(19) United States
(12) Patent Application Publication
(10) Pub. No.: US 2025/0365676 A1
(43) Pub. Date: Nov. 27, 2025

(54) OPEN LOOP UPLINK POWER CONTROL IN LOW-PASS CHANNELS

(71) Applicant: QUALCOMM Incorporated, San Diego, CA (US)

(72) Inventors: Morteza SOLTANI, San Diego, CA (US); Yisheng XUE, San Diego, CA (US); Xiaoxia ZHANG, San Diego, CA (US); Junyi LI, Greentown, PA (US); Jing SUN, San Diego, CA (US); Karoly BECZE, Escondido, CA (US); Sam LIU, San Diego, CA (US); Siva Kumar JUJARAY, San Diego, CA (US)

(21) Appl. No.: 18/670,530

(22) Filed: May 21, 2024

(51) Int. Cl. H04W 52/14; H04W 52/10; H04W 56/00; H04W 74/0833

(52) U.S. Cl. CPC H04W 52/146; H04W 52/10; H04W 56/0015; H04W 74/0833

(57) ABSTRACT

Methods, systems, and devices for wireless communications are described. A user equipment (UE) may receive synchronization signal blocks (SSBs) indicating an uplink transmit power and a first set of optical front-end (OFE) parameters for a network entity. The UE may transmit control signaling, indicating a second set of OFE parameters for the UE, with the uplink transmit power. The UE may transmit uplink signaling according to updated parameters based on the first set of OFE parameters. In some implementations, a UE may receive SSBs indicating a first uplink transmit power and a target uplink reception power and may transmit a first RACH message with a second uplink transmit power based on the first uplink transmit power. The UE may transmit a second RACH message according to a third uplink transmit power based on an uplink path loss indicated in a received RACH response message and the target uplink reception power.

### FIELD OF TECHNOLOGY

The following relates to wireless communications, including open loop uplink power control in low-pass channels.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by a user equipment (UE) is described. The method may include receiving one or more synchronization signal blocks (SSBs) indicating an uplink transmission power and a first set of optical front-end parameters associated with a network entity, transmitting, based on the one or more SSBs, control signaling according to the uplink transmission power, where the control signaling indicates a second set of optical front-end parameters associated with the UE, and transmitting uplink signaling according to one or more updated parameters based on the first set of optical front-end parameters associated with the network entity.

A UE for wireless communication is described. The UE may include one or more memories storing processor executable code, and one or more processors coupled with the one or more memories. The one or more processors may individually or collectively be operable to execute the code to cause the UE to receive one or more SSBs indicating an uplink transmission power and a first set of optical front-end parameters associated with a network entity, transmit, based on the one or more SSBs, control signaling according to the uplink transmission power, where the control signaling indicates a second set of optical front-end parameters associated with the UE, and transmit uplink signaling according to one or more updated parameters based on the first set of optical front-end parameters associated with the network entity.

Another UE for wireless communication is described. The UE may include means for receiving one or more SSBs indicating an uplink transmission power and a first set of optical front-end parameters associated with a network entity, means for transmitting, based on the one or more SSBs, control signaling according to the uplink transmission power, where the control signaling indicates a second set of optical front-end parameters associated with the UE, and means for transmitting uplink signaling according to one or more updated parameters based on the first set of optical front-end parameters associated with the network entity.

A non-transitory computer-readable medium storing code for wireless communication is described. The code may include instructions executable by one or more processors to receive one or more SSBs indicating an uplink transmission power and a first set of optical front-end parameters associated with a network entity, transmit, based on the one or more SSBs, control signaling according to the uplink transmission power, where the control signaling indicates a second set of optical front-end parameters associated with the UE, and transmit uplink signaling according to one or more updated parameters based on the first set of optical front-end parameters associated with the network entity.

Some examples of the method, UEs, and non-transitory computer-readable medium described herein may further include operations, features, means, or instructions for receiving downlink signaling based on transmitting the control signaling that indicates the second set of optical front-end parameters.

Some examples of the method, UEs, and non-transitory computer-readable medium described herein may further include operations, features, means, or instructions for updating one or more parameters from an initial set of one or more parameters to the one or more updated parameters, where the one or more updated parameters include an updated transmission power for the uplink signaling.

In some examples of the method, UEs, and non-transitory computer-readable medium described herein, the one or more SSBs may be received via an available bandwidth of at least one component carrier and the control signaling may be transmitted via the available bandwidth of the at least one component carrier.

Some examples of the method, UEs, and non-transitory computer-readable medium described herein may further include operations, features, means, or instructions for receiving via the one or more SSBs, system information indicating a transmission power for the control signaling, where in transmitting the control signaling may be based on the indicated transmission power.

In some examples of the method, UEs, and non-transitory computer-readable medium described herein, the uplink signaling may be transmitted via the available bandwidth of the at least one component carrier according to the first set of optical front-end parameters.

In some examples of the method, UEs, and non-transitory computer-readable medium described herein, the one or more SSBs may be received via a set of multiple sub-bands, an available bandwidth of at least one component carrier may be divided into the set of multiple sub-bands, and the control signaling may be transmitted via a first sub-band of the set of multiple sub-bands.

Some examples of the method, UEs, and non-transitory computer-readable medium described herein may further include operations, features, means, or instructions for selecting the first sub-band from the set of multiple sub-bands based on a quantity of UEs in a cell associated with the first sub-band, where transmitting the control signaling via the first sub-band of the set of multiple sub-bands may be based on the selecting.

In some examples of the method, UEs, and non-transitory computer-readable medium described herein, the uplink signaling may be transmitted via the first sub-band according to the first set of optical front-end parameters.

Some examples of the method, UEs, and non-transitory computer-readable medium described herein may further include operations, features, means, or instructions for receiving broadcast signaling indicating a set of candidate optical front-end parameters, a set of candidate transmission powers, or both, where the one or more SSBs include an indication of the uplink transmission power from the set of candidate transmit powers, an indication of the first set of optical front-end parameters from the set of candidate optical front-end parameters, or both.

In some examples of the method, UEs, and non-transitory computer-readable medium described herein, transmitting the uplink signaling according to the one or more updated parameters may include operations, features, means, or instructions for transmitting a first random access message, including a preamble, based on a calibration at the UE for uplink transmissions according to the one or more updated parameters and transmitting a second random access message based on the calibration and based on receiving a random access response message, where receiving the random access response message may be based on transmitting the first random access message.

A method for wireless communication by a network entity is described. The method may include outputting one or more SSBs indicating an uplink transmission power and a first set of optical front-end parameters associated with the network entity, obtaining, based on the one or more SSBs, control signaling according to the uplink transmission power, where the control signaling indicates a second set of optical front-end parameters associated with a UE, and outputting downlink signaling according to one or more updated parameters based on the second set of optical front-end parameters associated with the UE.

A network entity for wireless communication is described. The network entity may include one or more memories storing processor executable code, and one or more processors coupled with the one or more memories. The one or more processors may individually or collectively be operable to execute the code to cause the network entity to output one or more SSBs indicating an uplink transmission power and a first set of optical front-end parameters associated with the network entity, obtain, based on the one or more SSBs, control signaling according to the uplink transmission power, where the control signaling indicates a second set of optical front-end parameters associated with a UE, and output downlink signaling according to one or more updated parameters based on the second set of optical front-end parameters associated with the UE.

Another network entity for wireless communication is described. The network entity may include means for outputting one or more SSBs indicating an uplink transmission power and a first set of optical front-end parameters associated with the network entity, means for obtaining, based on the one or more SSBs, control signaling according to the uplink transmission power, where the control signaling indicates a second set of optical front-end parameters associated with a UE, and means for outputting downlink signaling according to one or more updated parameters based on the second set of optical front-end parameters associated with the UE.

A non-transitory computer-readable medium storing code for wireless communication is described. The code may include instructions executable by one or more processors to output one or more SSBs indicating an uplink transmission power and a first set of optical front-end parameters associated with the network entity, obtain, based on the one or more SSBs, control signaling according to the uplink transmission power, where the control signaling indicates a second set of optical front-end parameters associated with a UE, and output downlink signaling according to one or more updated parameters based on the second set of optical front-end parameters associated with the UE.

Some examples of the method, network entities, and non-transitory computer-readable medium described herein may further include operations, features, means, or instructions for obtaining uplink signaling based on outputting the one or more SSBs that indicate the first set of optical front-end parameters.

Some examples of the method, network entities, and non-transitory computer-readable medium described herein may further include operations, features, means, or instructions for updating one or more parameters from an initial set of one or more parameters to the one or more updated parameters, where the one or more updated parameters include an updated transmission power for the downlink signaling.

In some examples of the method, network entities, and non-transitory computer-readable medium described herein, the one or more SSBs may be output via an available bandwidth of at least one component carrier and the control signaling may be obtained via the available bandwidth of the at least one component carrier.

Some examples of the method, network entities, and non-transitory computer-readable medium described herein may further include operations, features, means, or instructions for outputting, via the one or more SSBs, system information indicating a transmission power for the control signaling, where obtaining the control signaling may be based on the indicated transmission power.

Some examples of the method, network entities, and non-transitory computer-readable medium described herein may further include operations, features, means, or instructions for outputting broadcast signaling indicating a set of candidate optical front-end parameters, a set of candidate transmission powers, or both, where the one or more SSBs include an indication of the uplink transmission power from the set of candidate transmit powers, an indication of the first set of optical front-end parameters from the set of candidate optical front-end parameters, or both.

In some examples of the method, network entities, and non-transitory computer-readable medium described herein, outputting the downlink signaling according to the one or more updated parameters may include operations, features, means, or instructions for outputting a first random access response message based on a calibration at the network entity for downlink transmissions according to the one or more updated parameters and based on obtaining a first random access message including a preamble and outputting a second random access response message based on the calibration and based on obtaining a second random access message, where obtaining the second random access message may be based on outputting the first random access response message.

A method for wireless communication by a UE is described. The method may include receiving one or more SSBs indicating a first uplink transmission power and a target uplink reception power, transmitting a first random access message, including a preamble, according to a second uplink transmission power, where the second uplink transmission power is based on the first uplink transmission power, receiving a random access response message corresponding to the first random access message, the random access response message including an indication of an uplink path loss, and transmitting a second random access message according to a third uplink transmission power, where the third uplink transmission power is based on the uplink path loss and the target uplink reception power.

A UE for wireless communication is described. The UE may include one or more memories storing processor executable code, and one or more processors coupled with the one or more memories. The one or more processors may individually or collectively be operable to execute the code to cause the UE to receive one or more SSBs indicating a first uplink transmission power and a target uplink reception power, transmit a first random access message, including a preamble, according to a second uplink transmission power, where the second uplink transmission power is based on the first uplink transmission power, receive a random access response message corresponding to the first random access message, the random access response message including an indication of an uplink path loss, and transmit a second random access message according to a third uplink transmission power, where the third uplink transmission power is based on the uplink path loss and the target uplink reception power.

Another UE for wireless communication is described. The UE may include means for receiving one or more SSBs indicating a first uplink transmission power and a target uplink reception power, means for transmitting a first random access message, including a preamble, according to a second uplink transmission power, where the second uplink transmission power is based on the first uplink transmission power, means for receiving a random access response message corresponding to the first random access message, the random access response message including an indication of an uplink path loss, and means for transmitting a second random access message according to a third uplink transmission power, where the third uplink transmission power is based on the uplink path loss and the target uplink reception power.

A non-transitory computer-readable medium storing code for wireless communication is described. The code may include instructions executable by one or more processors to receive one or more SSBs indicating a first uplink transmission power and a target uplink reception power, transmit a first random access message, including a preamble, according to a second uplink transmission power, where the second uplink transmission power is based on the first uplink transmission power, receive a random access response message corresponding to the first random access message, the random access response message including an indication of an uplink path loss, and transmit a second random access message according to a third uplink transmission power, where the third uplink transmission power is based on the uplink path loss and the target uplink reception power.

Some examples of the method, UEs, and non-transitory computer-readable medium described herein may further include operations, features, means, or instructions for increasing the second uplink transmission power according to a step value, the step value indicated in the one or more SSBs and transmitting a repetition of the first random access message according to the increased second uplink transmission power.

Some examples of the method, UEs, and non-transitory computer-readable medium described herein may further include operations, features, means, or instructions for switching from a first sub-band of a set of multiple sub-bands to a second sub-band of the set of multiple sub-bands, where an available bandwidth of at least one component carrier may be divided into the set of multiple sub-bands, receiving a second one or more SSBs via the second sub-band, where the second one or more SSBs indicates a third uplink transmission power, a second target uplink reception power, and a second step value, transmitting a third random access message according to a fourth uplink transmission power, the fourth uplink transmission power based on the increased second uplink transmission power, increasing the fourth uplink transmission power according to the second step value, and transmitting a repetition of the third random access message according to the increased third uplink transmission power.

Some examples of the method, UEs, and non-transitory computer-readable medium described herein may further include operations, features, means, or instructions for switching from a first sub-band of a set of multiple sub-bands to a second sub-band of the set of multiple sub-bands, where an available bandwidth of at least one component carrier may be divided into the set of multiple sub-bands, receiving a second one or more SSBs via the second sub-band, where the second one or more SSBs indicates a third uplink transmission power, a second target uplink reception power, and a second step value, transmitting a third random access message according to the third uplink transmission power, increasing the third uplink transmission power according to a second step value, the second step value indicated in the second one or more SSBs, and transmitting a repetition of the third random access message according to the increased third uplink transmission power.

Some examples of the method, UEs, and non-transitory computer-readable medium described herein may further include operations, features, means, or instructions for measuring a downlink path loss based on receiving the one or more SSBs, where the second uplink transmission power may be based on the downlink path loss.

In some examples of the method, UEs, and non-transitory computer-readable medium described herein, the one or more SSBs may be received via a set of multiple sub-bands, an available bandwidth of at least one component carrier may be divided into the set of multiple sub-bands, and the first random access message may be transmitted via a first sub-band of the set of multiple sub-bands.

In some examples of the method, UEs, and non-transitory computer-readable medium described herein, the one or more SSBs may be received via an available bandwidth of at least one component carrier and the random access message may be transmitted via the available bandwidth of the at least one component carrier.

In some examples of the method, UEs, and non-transitory computer-readable medium described herein, the random access response message, including a second target uplink reception power for a sub-band of a set of multiple sub-bands, may be received via the sub-band, the available bandwidth of the at least one component carrier may be divided into the set of multiple sub-bands, and the second random access message may be transmitted via the sub-band according to the second target uplink reception power.

Some examples of the method, UEs, and non-transitory computer-readable medium described herein may further include operations, features, means, or instructions for selecting the sub-band from the set of multiple sub-bands based on the uplink path loss and the second target uplink reception power.

In some examples of the method, UEs, and non-transitory computer-readable medium described herein, the first uplink transmission power and the second uplink transmission power may be the same.

Some examples of the method, UEs, and non-transitory computer-readable medium described herein may further include operations, features, means, or instructions for selecting a preamble sequence, where transmitting the first random access message may be based on the preamble sequence.

A method for wireless communication by a network entity is described. The method may include outputting one or more SSBs indicating a first uplink transmission power and a target uplink reception power, obtaining a first random access message, including a preamble, according to a second uplink transmission power, where the second uplink transmission power is based on the first uplink transmission power, outputting a random access response message corresponding to the first random access message, the random access response message including an indication of an uplink path loss, and obtaining a second random access message according to a third uplink transmission power, where the third uplink transmission power is based on the uplink path loss and the target uplink reception power.

A network entity for wireless communication is described. The network entity may include one or more memories storing processor executable code, and one or more processors coupled with the one or more memories. The one or more processors may individually or collectively be operable to execute the code to cause the network entity to output one or more SSBs indicating a first uplink transmission power and a target uplink reception power, obtain a first random access message, including a preamble, according to a second uplink transmission power, where the second uplink transmission power is based on the first uplink transmission power, output a random access response message corresponding to the first random access message, the random access response message including an indication of an uplink path loss, and obtain a second random access message according to a third uplink transmission power, where the third uplink transmission power is based on the uplink path loss and the target uplink reception power.

Another network entity for wireless communication is described. The network entity may include means for outputting one or more SSBs indicating a first uplink transmission power and a target uplink reception power, means for obtaining a first random access message, including a preamble, according to a second uplink transmission power, where the second uplink transmission power is based on the first uplink transmission power, means for outputting a random access response message corresponding to the first random access message, the random access response message including an indication of an uplink path loss, and means for obtaining a second random access message according to a third uplink transmission power, where the third uplink transmission power is based on the uplink path loss and the target uplink reception power.

A non-transitory computer-readable medium storing code for wireless communication is described. The code may include instructions executable by one or more processors to output one or more SSBs indicating a first uplink transmission power and a target uplink reception power, obtain a first random access message, including a preamble, according to a second uplink transmission power, where the second uplink transmission power is based on the first uplink transmission power, output a random access response message corresponding to the first random access message, the random access response message including an indication of an uplink path loss, and obtain a second random access message according to a third uplink transmission power, where the third uplink transmission power is based on the uplink path loss and the target uplink reception power.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support open loop uplink power control in low-pass channels in accordance with one or more aspects of the present disclosure.

FIGS. 3 and 4 show examples of process flows that support open loop uplink power control in low-pass channels in accordance with one or more aspects of the present disclosure.

FIGS. 5 and 6 show block diagrams of devices that support open loop uplink power control in low-pass channels in accordance with one or more aspects of the present disclosure.

FIG. 7 shows a block diagram of a communications manager that supports open loop uplink power control in low-pass channels in accordance with one or more aspects of the present disclosure.

FIG. 8 shows a diagram of a system including a device that supports open loop uplink power control in low-pass channels in accordance with one or more aspects of the present disclosure.

FIGS. 9 and 10 show block diagrams of devices that support open loop uplink power control in low-pass channels in accordance with one or more aspects of the present disclosure.

FIG. 11 shows a block diagram of a communications manager that supports open loop uplink power control in low-pass channels in accordance with one or more aspects of the present disclosure.

FIG. 12 shows a diagram of a system including a device that supports open loop uplink power control in low-pass channels in accordance with one or more aspects of the present disclosure.

FIGS. 13 through 19 show flowcharts illustrating methods that support open loop uplink power control in low-pass channels in accordance with one or more aspects of the present disclosure.

### DETAILED DESCRIPTION

Some wireless communications systems may support optical wireless communication (OWC) to transmit or receive information. Some OWC systems may operate in an optical spectrum between approximately 1011 and 1016 hertz (Hz). For example, a first device may transmit an optical wireless signal (e.g., a signal in the infrared to ultraviolet spectrum) to a second device via a beam of light using a light source. The second device may receive the optical wireless signal using a photodetector. The various parameters and elements utilized to transmit or receive OWC signaling (e.g., a type of light source, a type of diode, a light-emitting diode (LED), a direct current (DC) bias, a type of or parameters for a photodetector, among other examples) may be referred to as an optical front end (OFE) of a device. Some optical channels may offer relatively little or no fading, while tending to increasingly attenuate signals with increasing frequency. The attenuation characteristic may be referred to as a “low-pass” characteristic, where signals in a relatively lower band may exhibit little or no attenuation, while some relatively higher-frequency signals may be increasingly attenuated as the frequency increases.

Accordingly, path loss for OWC channels, and similar frequency ranges, may be frequency dependent. Path loss may be dependent on various parameters, such as the relative distance between the network entity and the UE, center frequency, shadow fading, and path loss exponent, among other factors. In radio frequency (RF) systems, if a user equipment (UE) is relatively static, the surrounding environment is static, and the UE is operating on a fixed center frequency, the path loss may not change frequently or may stay within a given range. However, in OWC signaling or other communications via similar frequencies, the channel may be non-fading and may exhibit low pass behavior. Thus, even if the UE and environment of the UE are static, the path loss may be different for different bandwidths, subcarriers, or frequencies. Further, path loss for uplink and downlink communications may not be the same across frequencies. That is, path loss may differ depending on communication direction (e.g., uplink or downlink). Because of the frequency selective path-loss in OWC signaling, and the link direction dependency of the OWC signaling, power control calculation and selection for wireless devices may be impacted.

Techniques described herein provide for power control through calibration at a network entity and calibration at a UE to improve strong low-pass channel communications. In some implementations, the network entity and the UE may be calibrated to have similar path loss for uplink communication and downlink communication. For example, the network entity may output synchronization signal blocks (SSBs) indicating parameters (e.g., OFE parameters) associated with downlink transmission and the UE may update other parameters (e.g., uplink transmit power, sub-band choice) to compensate for the downlink path loss, based on the parameters indicated by the network entity. The UE may also transmit control signaling indicating parameters (e.g., OFE parameters) associated with uplink transmission. Based on the parameters indicated by the UE, the network entity may update other parameters (e.g., transmit power, sub-band choice) to compensate for the uplink path loss. The calibration at the network entity and the calibration at the UE may be done via wideband or sub-band communication.

In some implementations, the UE may calibrate an uplink transmit power, to account for uplink path loss, during a random access (e.g., physical random access channel (PRACH)) process by updating an uplink transmit power based on an indication of the uplink path loss from the network entity. For example, the network entity may output SSBs that indicate uplink transmit powers and target uplink reception powers. The UE may transmit a first random access message (including a preamble) based on an uplink transmit power associated with a wideband or desired sub-band. In some cases, the UE may also use a ramping parameter (e.g., step value) indicated in the SSBs to increase the uplink transmit power of the random access message until it is successfully received at the network entity. Then, the network entity may determine uplink path loss and output a second random access message to the UE indicating the uplink path loss. Based on the uplink path loss, the UE may proceed with the random access process using updated transmit power based on the path loss and the target uplink reception power. Such techniques may be applied as a sub-band (e.g., narrow band) specific initial access procedure, or as a wideband initial access procedure.

Aspects of the disclosure are initially described in the context of wireless communications systems and process flows. Aspects of the disclosure are further illustrated by and described with reference to apparatus diagrams, system diagrams, and flowcharts that relate to open loop uplink power control in low-pass channels.

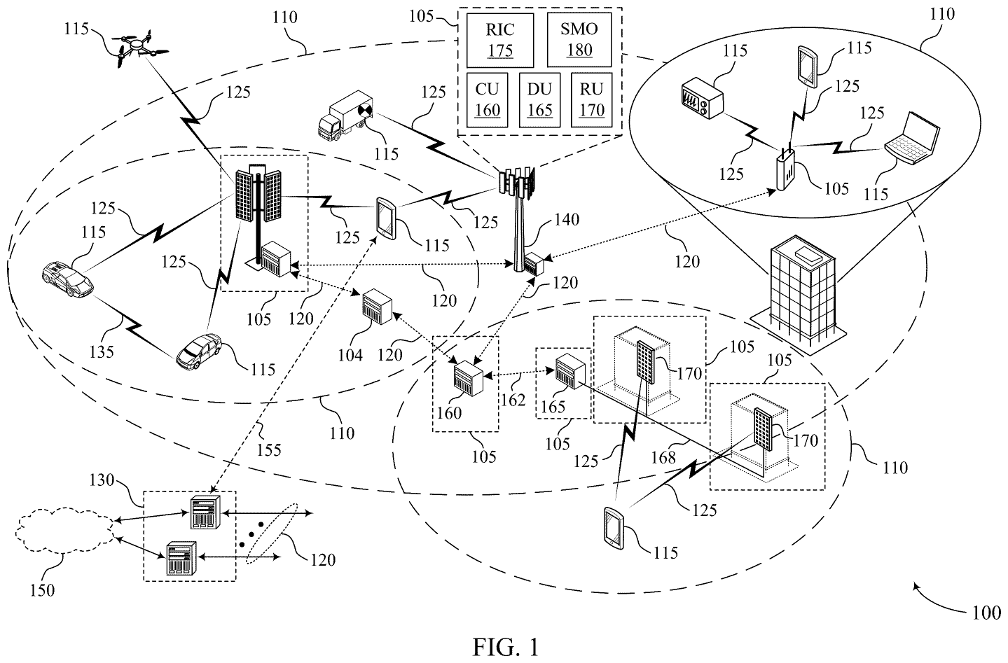

FIG. 1 shows an example of a wireless communications system 100 that supports open loop uplink power control in low-pass channels in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Future wireless systems may use higher data throughput or more data per second per link. Radio frequency, particularly lower radio frequency (e.g., sub 100 gigahertz (GHz)), spectrums may be unable to support high data throughput demands. OWC may provide higher frequency spectrums (e.g., 10¹³ to 10¹⁶ hertz (Hz) to help resolve the demands for higher data throughput. A network entity 105 and a UE 115 may communicate via an OWC. Some OWC systems may operate in an optical spectrum between approximately 10¹¹ and 10¹⁶ Hz. For example, the transmitting device (e.g., the UE 115, the network entity 105) may transmit an optical wireless signal (e.g., a signal in the infrared to ultraviolet spectrum) to the receiving device (e.g., the UE 115, the network entity 105) via a beam of light using a light source. The receiving device may receive the optical wireless sign using a photodetector. One or more light sources or photodetectors may be referred to as an OFE of a device. Some optical channels may offer relatively little or no fading, while tending to increasingly attenuate signals with increasing frequency. The attenuation characteristic may be referred to as a “low-pass” characteristic. OWC and similar channels may present low-pass behavior as the result of combining the behavior of waveform responses in LEDs and laser diodes, responses in photodetectors, and responses in a wireless medium used for transmission of signals. The wireless medium may be flat or frequency selective depending on line-of-sight and non-line-of-sight conditions. In some cases, an OWC may be relatively static, presenting a stable link, such as in point-to-point communication.

In general, path loss for OWC channels, and similar frequency ranges, may be frequency dependent. Thus, even if the UE 115 and environment are static, the path loss may be different for different bandwidths. That is, path loss for uplink and downlink communications may not be consistent across frequencies. Further, there may be frequency selective transmission-originated distortions in OWC systems, such as nonlinearities that may be induced by electrical-to-optical conversions and the use of LEDs or laser diodes. There may also be reception-originated distortions that may be introduced based on the OFE used. In some cases, these may be optical-to-electrical conversion nonlinearities or diode-based nonlinearities.

The UE 115 may communicate with the network entity 105 using uplink power control. Uplink power control may determine the power of transmissions from the UE (e.g., physical uplink shared channel (PUSCH), physical uplink control channel (PUCCH), sounding reference signal (SRS), and PRACH transmission). Uplink power control may help reduce intra-cell and inter-cell interference, as well as UE power consumption. In general, power control may be based on path loss. The UE 115 may maintain path loss estimates for uplink transmissions. For example, in some wireless systems (e.g., 5G NR systems), a UE 115 may maintain up to four path loss estimates for uplink transmissions. Power control may be open loop or closed loop power control. Open loop power control may be relevant for a UE 115 establishing a connection to a network. Closed loop power control may be relevant to power control once the UE 115 may be connected to the network. Power control may be defined by multiple parameters. For example, open loop power control may rely on target reception power, as set by the network entity 105, and a path loss factor. Closed loop power control may include the target reception power and the path loss factor, as well as a modulation and coding scheme (MCS) factor, a resource block (RB) factor, and a power control command. Power control may be defined by the following Equation 1:

$$Transmit Power at UE = Target Reception Power set by Network Entity + Path Loss Factor + MCS Factor + RB Factor + Power Control Command \qquad ( 1 )$$

Open loop power control parameters in Equation 1 may be Target Reception Power set by Network Entity and Path Loss Factor. Closed loop power control parameters in Equation 1 may be Target Reception Power set by Network Entity, Path Loss Factor, MCS Factor, RB Factor, and Power Control Command.

Open loop power control may set the transmit power of the UE 115 for uplink connections. This may be determined when the UE 115 establishes (or re-establishes) connection to the network entity 105. For example, the open loop power control may define a PRACH (e.g., random access) transmit power. Closed Loop Power control may set the transmit power of the UE 115 for uplink connections when the UE may be connected to the network entity 105. For example, the closed loop power control may define a PUCCH, PUSCH, or SRS transmit power.

As described herein, path loss in OWC may be frequency selective and link direction dependent. During an initial access process (e.g., the UE 115 establishing a connection to network entity 105), uplink and downlink path loss may not be known by either the network entity 105 or the UE 115. Further, the difference between the uplink and downlink path loss in strong low-pass channel communications (e.g., OWC) may be frequency selective. Contrastingly, radio frequency-based communications may have relatively identical uplink and downlink path loss within the same component carrier (both in the FDD and TDD) case. Thus, uplink power control may be used during initial access for strong low-pass channel communications.

In some cases, conventional methods (e.g., 5G/6G standards documentation) may be used to enable OWC communication. For example, conventional waveforms may be used for OWC. In some examples, a conventional waveform and conventional waveform generation techniques may be adjusted for OWC communication, such as adding biases (e.g., DC bias) or adjusting frequencies (e.g., adding an up-conversion to an intermediate frequency (IF)). OWC systems may provide reliable and robust communication while leveraging enhancements to conventional methods. Further, physical and higher layer protocols may be readily applied to OWC systems. As compared to RF communication, OWC systems may use OFEs, as opposed to radio frequency front ends. In some implementations, OWC may be used for broad coverage, not just point-to-point communication.

Transmit power and power control may be used in OWC systems. According to standards documentation, a UE 115 may determine PRACH transmit power using the below equation 2:

$${P}_{PRACH , b , f , c} = min \{ {P}_{CMAX , f , c} ( i ) , {P}_{PRACH , target , f , c} + {PL}_{b , f , c} \} [ dBm ] \qquad ( 2 )$$

P_{PRACH,b,f,c} may represent a transmit power P, where PRACH may identify the transmit power as being for a PRACH transmission, b may be an uplink bandwidth part, f may be a carrier frequency, and c may be a serving cell. i may represent a transmission occasion. P_{CMAX,f,c} may represent the configured maximum UE output power for a carrier frequency f of serving cell c in each slot (e.g., the tolerance). P_{CMAX,f,c} may be less than or equal to P_{CMAX_H,f,c} and P_{CMAX,f,c} may be greater than or equal to P_{CMAX_L,f,c}. H may represent a high, or maximum, and L may represent a low, or minimum. Further, the following equation 3 and equation 4 may define P_{CMAX_L,f,c} and P_{CMAX_H,f,c}, respectively:

$${P}_{CMAX \_ L , f , c} = min \{ {P}_{EMAX , c} , {P}_{PowerClass} - Δ {P}_{PowerClass} \} \qquad ( 3 )$$

$${P}_{CMAX \_ H , f , c} = min \{ {P}_{EMAX , c} - Δ {T}_{C , c} , ( {P}_{PowerClass} - Δ {P}_{PowerClass} ) - max ( {MPR}_{c} + A - {MPR}_{C} + Δ {T}_{IB , c} + Δ {T}_{C , c} + {ΔT}_{RxSRS} , P - {MPR}_{c} ) \} \qquad ( 4 )$$

Further, P_{CMAX,f,c} should be configured so that P_{UMAX,f,c} may be within the boundary P_{PowerClass}−max (MPR_{f,c}, PMPR_{f,c})−max{T(MPR_{f,c})}≤P_{UMAX,f,c}≤EIRPₘₐₓ where the measured total radiated power may be related to the maximum total radiated power as so: P_{TMAX,f,c}≤TRPₘₐₓ·P_{UMAX} may be the measured configured maximum UE output power. P_{EMAX} may be a maximum allowed UE output power signaled by higher layers. That is, P_{EMAX} may be a value indicated by the network entity 105-a, such as a maximum power, Pmax, indicated in an RRC message. P_{PowerClass} may be the maximum allowed power for a power class (without considering tolerance) and may depend on a frequency range (e.g., FR1, FR2). ΔT_{C,c} may be a change in tolerance for the lower tolerance limit for a serving cell c. ΔT_{IB,c} may be an allowed operating band edge transmit power relaxation for serving cell c. MPR_{c} may be a maximum power reduction for a serving cell c. A-MPR_{c} may be an additional maximum power reduction for serving cell c. P-MPR_{c} may be a power management maximum power reduction for a serving cell c. ΔT_{RxSRS} may be a difference in tolerance for a received SRS.

P_{PRACH,target,f,c} may represent the PRACH target reception power or the target base reception power at a network entity 105, which may be equal to the PREAMBLE_RECEIVED_TARGET_POWER. In RRC, this may be equal to the preambleReceivedTargetPower+DELTA_PREAMBLE+ (PREAMBLE_POWER_RAMPING_COUNTER−1)×PREAMBLE_POWER_RAMPING_STEP. This may be a description of a power ramping procedure. PL_{b,f,c} may represent a path loss factor, or a path loss for the active uplink bandwidth part b of carrier frequency f based on a downlink reference signal associated with the PRACH transmission on the active downlink bandwidth part of serving cell c. This may be equal to referenceSignalPower-HigherLayerFilteredRSRP (reference signal received power). dBm may indicate that the equation may be in units of decibel-milliwatts.

In determining PRACH transmit power, at least two parameters may be relevant, referenceSignalPower and PREAMBLE_RECEIVED_TARGET_POWER. To determine referenceSignalPower, ss-PBCH-BlockPower may be used as a reference signal, where ss-PBCH-BlockPower may be a synchronization signal-physical broadcast channel (ss-PBCH) block power. The ss-PBCH-BlockPower may be an RRC parameter received by the UE 115 on a system information block (e.g., SIB1) via PBCH during an initial access procedure. The UE 115 may estimate path loss based on the ss-PBCH-BlockPower and a reference power that may be measured by the UE 115. There may be multiple cases in which to determine PRACH transmit power using ss-PBCH. One example that may not use ss-PBCH-BlockPower as a reference signal may be when the PRACH may be in response to a detection of a PDCCH order by the UE 115 that may trigger a non-contention based PRACH procedure and the UE 115 may be configured with resources for a periodic channel status information reference signal (CSI-RS) reception. Another example that may not use ss-PBCH-BlockPower as a reference signal may be when the PRACH may be associated with a link recovery procedure. To determine PREAMBLE_RECEIVED_TARGET_POWER, the PRACH target reception power, the below equation 5 may be used:

$$PREAMBLE\_RECEIVED \_TARGET \_POWER = preambleReceivedTargetPower + DELTA\_PREAMBLE + ( PREAMBLE\_POWER \_RAMPING \_COUNTER - 1 ) \times PREAMBLE\_POWER \_RAMPING \_STEP \qquad ( 5 )$$

The preambleReceivedTargetPower may be determined by an RRC message received on a system information block (e.g., SIB1) in a PBCH block over an initial access procedure. This parameter may specify the target power level for the PRACH transmissions. The UE 115 may adjust an uplink transmit power so that the preamble may be received at the network entity 105 above this target power level. The PREAMBLE_POWER_RAMPING_STEP may be determined by an RRC message received on a system information block (e.g., SIB1) in a PBCH block over an initial access procedure. This parameter may be involved in power control mechanisms during the random access procedure. The initial preamble transmission may not be successful (i.e., the UE 115 does not receive a response from the network entity 105). In this case, the UE will increase the uplink transmit power for a next preamble attempt. The DELTA_PREAMBLE may be determined by a pre-defined table (e.g., a direct mapping between preamble formats, i.e., long or short, and DELTA-PREAMBLE values). The PREAMBLE_POWER_RAMPING_COUNTER may start from 1 and increment by 1 every time PRACH may be retransmitted until it reaches a maximum (which may be given by RRC signaling). In some cases, the network entity 105 may configure the UE 115 to set parameters for uplink power control.

Techniques described herein provide for power control through calibration at a network entity 105 and calibration at a UE 115 to improve strong low-pass channel communications. In some implementations, the network entity 105 and the UE 115 may be calibrated to have similar path loss for uplink communication and downlink communication. For example, the network entity 105 may output SSBs indicating parameters (e.g., OFE parameters) associated with downlink transmission and the UE 115 may update other parameters (e.g., uplink transmit power, sub-band choice) to compensate for the downlink path loss, based on the parameters indicated by the network entity. The UE 115 may also transmit control signaling indicating parameters (e.g., OFE parameters) associated with uplink transmission. Based on the parameters indicated by the UE 115, the network entity 105 may update other parameters (e.g., transmit power, sub-band choice) to compensate for the uplink path loss. The calibration at the network entity and the calibration at the UE 115 may be done via wideband or sub-band communication.

In other implementations, the UE 115 may calibrate an uplink transmit power, to account for uplink path loss, during a random access (e.g., PRACH) process by updating an uplink transmit power based on an indication of the uplink path loss from the network entity. For example, the network entity 105 may output SSBs that indicate uplink transmit powers and target uplink reception powers. The UE 115 may transmit a random access message (including a preamble) based on an uplink transmit power associated with a wideband or desired sub-band. In some cases, the UE 115 may also use a ramping parameter (e.g., step value) indicated in the SSBs to increase the uplink transmit power of the random access message until it is successfully received at the network entity 105. Then, the network entity 105 may determine uplink path loss and output a second random access message to the UE 115 indicating the uplink path loss. Based on the uplink path loss, the UE 115 may proceed with a random access process using updated transmit power based on the path loss and the target uplink reception power. Such techniques may be applied as a sub-band (e.g., narrow band) specific initial access procedure, or as a wideband initial access procedure.

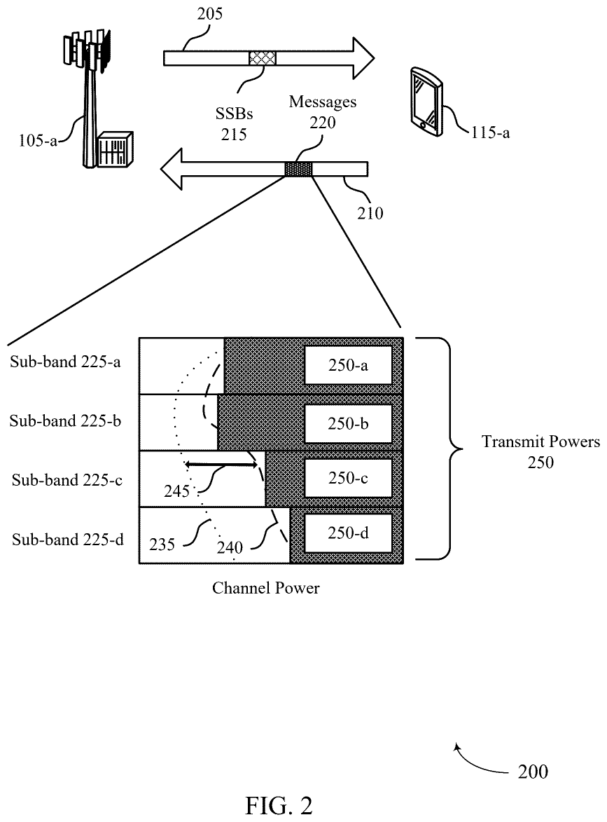

FIG. 2 shows an example of a wireless communications system 200 that supports open loop uplink power control in low-pass channels in accordance with one or more aspects of the present disclosure. The wireless communications system 200 describes the communications between a UE 115-a and a network entity 105-a. In some examples, aspects of the wireless communications system 200 may implement or be implemented by aspects of the wireless communications system 100. For example, the wireless communications system 200 may include the UE 115-a and the network entity 105-a, which may be examples of the corresponding devices as described herein, including with reference to FIG. 1.

The network entity 105-a and the UE 115-a may communicate via a channel with a strong low-pass characteristic and little to no fading, such as an OWC channel, using downlink 205 and uplink 210. Communications via such a channel may be performed across an available bandwidth of a component carrier (e.g., an entire component carrier). In some cases, SSBs 215 may be sent via the available bandwidth of the component carrier on the downlink 205, and messages 220 may be sent via the available bandwidth of the component carrier on the uplink 210. In other cases, the available bandwidth of the component carrier may be divided into sub-bands 225 (e.g., sub-band 225-a, sub-band 225-b, sub-band 225-c, and sub-band 225-d). In such examples, communications may occur via individual sub-bands 225.

Path loss for the channel, and similar frequency ranges, may be frequency dependent. For example, downlink power 235 may represent the downlink power of the channel as it changes with frequency. Uplink power 240 may represent the uplink power of the channel as it changes with frequency. Downlink power 235 and uplink power 240 may vary across frequency, such as for different sub-bands 225, which may allow for a determination of path loss. That is, even if the UE 115-a and environment are static, the path loss may be different for different bandwidths and sub-bands 225. Additionally, or alternatively, path loss for uplink and downlink communications may not be consistent or regular across frequencies. For example, the downlink power 235 and the uplink power 240 for may not be the same. Instead, there may be a path loss gap 245. Further, the path loss gap 245 may be frequency dependent. That is, the path loss gap 245 may be different at different sub-bands. For example, the path loss gap 245 may be smaller at sub-band 225-a than the path loss gap 245 at sub-band 225-c. The frequency selectivity or low-pass characteristic and the link direction dependency of path loss may impact uplink power control procedures for the channel, in particular during initial access of the UE 115-a to the channel (e.g., while connecting to network entity 105-a).

Initial access power control procedures, particularly uplink power control for PRACH, may be used to account for (e.g., and compensate for) the frequency selectivity and the link direction dependency of the channel. The initial access power control procedures may enable the UE 115-a to successfully perform an initial access (e.g., PRACH) procedure and connect to a network, enabling the UE 115-a to communicate with the network entity 105-a. Additionally, or alternatively, the initial access power control procedures may ensure that when the UE 115-a uses a sub-band 225 that may suffer a relatively large path loss, such as sub-band 225-b, the UE 115-a may still be able to communicate with the network entity 105-a.

In some implementations, the UE 115-a and the network entity 105-a may be calibrated such that the experienced path loss for uplink communications and downlink communications may be relatively the same. That is, the UE 115-a may pre-compensate for the frequency selectivity of the path loss for the uplink 210 before transmission via the uplink 210, and the network entity 105-a may pre-compensate for the frequency selectivity of the path loss for the downlink 205 before transmission on the downlink 205. In some cases, to perform the calibration, the UE 115-a may gain access to information indicating the OFE parameters of network entity 105-a. Additionally, or alternatively, the network entity 105-a may gain access to information indicating the OFE parameters of UE 115-a to perform the calibration. These parameters may be sent or indicated between devices, according to techniques described herein. That is, the calibration may allow both the network entity 105-a and the UE 115-a to learn about the path loss of the channel on each link direction at the initial access, or connection, stage. In some cases, after calibration, the UE 115-a and the network entity 105-a may perform a PRACH procedure (e.g., each device having determined and compensated for the relevant path loss based on determining OFE parameters at the other device).

To enable the network entity 105-a and the UE 115-a to calibrate during an initial access procedure (e.g., in the beginning of establishing the connection) such that the path loss in the uplink and downlink direction may be similar, the network entity 105-a may send SSBs 215. An SSB 215 may include an indication of one or more OFE parameters for the network entity 105-a. The OFE parameters may include an indication of a type of Laser Diode or LED, a DCI bias, a device type, among other examples. The UE 115-a may receive the SSB 215 and may learn about the downlink channel profile based on the OFE parameters at the network entity 105-a and second OFE parameters at the UE 115-a. Additionally, or alternatively, the UE 115-a may transmit an indication of the second OFE parameters to the network entity 105-a in a message 220. The message 220 may be sent according to an uplink transmit power 250 (e.g., the transmit power 250-a, the transmit power 250-b, the transmit power 250-c, and the transmit power 250-d). The network entity 105-a may obtain the message 220 and may learn about the uplink channel profile based on the second OFE parameters at the UE 115-a and the OFE parameters at the network entity 105-a. After the network entity 105-a learns about the downlink channel profile and the UE 115-a learns about the uplink channel profile, the network entity 105-a may update one or more parameters (e.g., transmit power, sub-band selection) and the UE 115-a may update one or more parameters (e.g., transmit power, sub-band selection) to pre-compensate for the frequency selectivity and link direction dependency of the channel.

The SSB(s) 215 may be output (e.g., transmitted) by the network entity 105-a over the air, or the indication of the first set of OFE parameters at the network entity 105-a may be provided to the UE 115-a offline. For example, for over the air calibration, the SSB(s) 215 may include system information such as a first system information block (SIB) (e.g., SIB1). The first SIB may include information about a first set (e.g., one or more) of OFE parameters at the network entity 105-a, which may be used by the UE 115-a for calibration. Additionally, or alternatively, the first SIB may include a value for uplink transmit power 250 (e.g., a first uplink transmit power) at the UE 115-a. In other examples, such as for offline calibration, the network entity 105-a may have access to a set of tables or formulas. The network entity 105-a may broadcast an indication of the table or formulas over the SSB(s) 215 (e.g., SIB 1 of each SSB may include an indication of a set of tables or formulas for calibration by the UE 115-a). The first SIB may indicate a table, set of tables, or formulas for the UE 115-a to use for calibration. For instance, the network entity 105-a may output, via broadcast signaling, an indication of a set of candidate OFE parameters, a set of candidate transmit powers, or both, where the SSB(s) includes an indication of the uplink transmit power from the set of candidate uplink transmit powers, an indication of the first set of OFE parameters from the set of candidate OFE parameters, or both.

In some cases, the SSB(s) 215 may be output by the network entity 105-a over an available bandwidth (which may be an entire bandwidth) of a component carrier (e.g., wideband SSBs 215). In other cases, the available bandwidth of the component carrier may be divided into sub-bands 225 and the SSB(s) 215 may be output via a sub-band 225 (e.g., per sub-band 225). In some cases, the parameters of the sub-bands 225 may be preconfigured. A sub-band 225 may be associated with a respective transmit power 250. For example, sub-band 225-a is associated with transmit power 250-a. In some examples (e.g., where the SSBs are transmitted per sub-band), the first SIB (e.g., SIB1) in each SSB may include an indication of the first set of OFE parameters for UE 115-a calibration (e.g., the OFE parameters at the network entity 105-a). In some examples, the SIB 1 of each SSB may include an indication of a value for the UEs 115 subsequent uplink transmit power.

The messages 220 may further include control signaling from the UE 115-a to the network entity 105-a. The UE 115-a may transmit the control signaling to the network entity 105-a. The control signaling may include an indication of the OFE parameters at the UE 115-a for the network entity 105-a to use for calibration. In some cases, the control signaling may be considered as a pre-cursor to an initial access or PRACH procedure (e.g., a PRACH Message 0, transmitted for network entity 105-a calibration). The control signaling may be sent according to some uplink transmit power 250 (e.g., the first uplink transmit power, a second uplink transmit power). In some cases, if the network entity 105-a output the SSB(s) via an entire available bandwidth, the UE 115-a may transmit the control signaling via the entire available bandwidth. The uplink transmit power 250 of the control signaling may be set by the first system information block of the SSB(s) (e.g., SIB1 may include an indication of the transmit power the UE 115-a is to use for sending the message 0). In other cases, if the UE 115-a received the SSB(s) on particular sub-bands 225, the UE 115-a may transmit the control signaling on a particular sub-band 225. The uplink transmit power 250 of the control signaling may be set by the first system information block of the SSB(s) for the sub-band 225 (e.g., a SIB1 received via sub-band 225-a may include an indication of a transmit power 250-a to be used for transmitting the message 0 via the sub-band 225-a). In some examples, the UE 115-a may select a sub-band 225 for transmission of the control message indicating the OWC parameters for the UE 115-a. Sub-band selection may be based on a number of factors, such as the quantity of UEs 115 in a cell for the sub-band 225.

After the UE 115-a and the network entity 105-a have calibrated such that the experienced path loss for uplink communications and downlink communications may be relatively the same, the UE 115-a and the network entity 105-a may proceed with initial access procedures, such as transmitting uplink signaling (e.g., PRACH message 1 and 3) and receiving downlink signaling (e.g., PRACH Message 2 and 4) according to a PRACH procedure. To transmit uplink signaling, the UE 115-a may update one or more parameters (e.g., pre-compensate the frequency selectivity and link direction dependency). Updating the parameters may include adjusting the uplink transmit power 250 or selecting a new sub-band 225. Similarly, the network entity 105-a may update parameters, such as adjusting a downlink transmit power. Additionally, or alternatively, the UE 115-a may apply uplink open loop power control parameters, such as target PRACH power and uplink path loss, to further improve uplink signaling and transmission. For instance, the uplink path loss may be measured by the UE 115-a, since the UE 115-a may have access to information including the uplink channel profile. That is, the UE 115-a may use the SSB 215 as a reference signal to compensate in both wideband (e.g., an entire component carrier, an available bandwidth of a component carrier) or narrowband situations (e.g., over each sub-band 225). For instance, the uplink path loss may be equal to the difference between a reference signal power (e.g., a referenceSignalPower, which may be sent in the first information block), and a filtered and compensated reference signal received power (RSRP) (e.g., the HigherLayerFilteredRSRPAfterCompensation).

In some examples, initial access and compensation for path loss and power control may be performed during an initial access or random access procedure. For example, direct calibration between the UE 115-a and the network entity 105-a may not be feasible (e.g., if there are many UEs 115 trying to join a network or in a network). Instead, the UE 115-a may perform an initial access procedure and uplink PRACH power control procedure to account for the path loss gap 245 and the frequency selectivity of the channel. In this case, the network entity 105-a may not have access to information about the OFE parameters of the UE 115-a prior to performing the initial access procedure. Additionally, or alternatively, the UE 115-a may not have access to information regarding the OFE parameters of the network entity 105-a prior to performing the initial access procedure. That is, the UE 115-a may determine the frequency selectivity and link direction dependency of the path loss without initial access to information about the OFE parameters of the network entity 105-a. Additionally, or alternatively, the network entity 105-a may determine the frequency selectivity and link direction dependency of the path loss without initial access to information about the OFE parameters of the UE 115-a. As described herein, initial access procedures (e.g., without calibration) may be performed as sub-band (e.g., narrow-band) specific initial access procedures with uplink PRACH power control, or as wideband initial access with uplink PRACH power control.

In some cases, the initial access procedure and the uplink PRACH power control procedure may be performed on a sub-band 225 (e.g., narrowband or sub-band based initial access). That is, the UE 115-a and the network entity 105-a may perform sub-band based PRACH transmit power determination, and the UE 115-a may perform a random access procedure with a pre-configured uplink transmit power indicated by SIB1 of SSBs over a specific sub-band. For example, the UE 115-a may receive SSB(s) 215 over sub-bands 225 and may perform PRACH with a pre-configured uplink transmit power indicated by the first system information block of the SSB(s) for a respective sub-band 225. The UE 115-a may select sub-band 225-c from available sub-bands 225 over which UE received SSBs. Further, the UE 115-a may choose a preamble sequence, and may transmit a first random access message (e.g., PRACH Message 1) with an uplink transmit power (e.g., which may be referred to as an initial transmit power P₀) indicated by the first system information block (e.g., SIB1) of the SSB received on the sub-band 225-c. The first random access message may be an example of messages 220. In some examples, since the UE 115-a may not have access to information about the uplink path loss, the first uplink transmit power may not be sufficient for the network entity 105-a to obtain the first random access message. That is, the first uplink transmit power may not compensate for both the target reception power for the first random access message (e.g., as indicated by the parameter TargetPRACHRxPower) and the uplink path loss. In some cases, the UE 115-a may measure the downlink path loss based on the SSB 215 as a starting point for determining if the first uplink transmit power 250-c (e.g., P₀) may be sufficient for successful uplink transmission. In some cases, a power ramping procedure may be used to update the uplink transmit power 250-c.

After obtaining the first random access message over the sub-band 225-c with an uplink transmit power 250-c (e.g., P₀), the network entity 105-a may measure the uplink path loss. Then, the network entity 105-a may output a random access response message (e.g., PRACH Message 2) to the UE 115-a via the sub-band 225-c, where the random access response message indicates the uplink path loss. That is the network entity 105-a may signal the uplink path loss to the UE 115-a in the random access response message. Once the UE 115-a receives the indication of the uplink path loss over the sub-band 225-c, the UE 115-a may compensate for the uplink path loss. That is, the UE 115-a may transmit a second random access message (e.g., PRACH Message 3) with a third (e.g., different) uplink transmit power 250-c on the sub-band 225-c that may account for the uplink path loss and a target reception power for a preamble (e.g., e.g., as indicated by a parameter such as PREAMBLE_RECEIVED_TARGET_POWER). For example, the UE 115-a may increase the uplink transmit power 250 to account for the uplink path loss such that the second random access message may be received at the target reception power. In some examples, the target reception power for the preamble may be sub-band specific and may be determined through a power ramping procedure. That is, the target reception power for the preamble may be determined based on a step value (e.g., a ramping parameter) and the indicated target reception power (e.g., preambleReceivedTargetPower), where both of the latter parameters may be indicated via the first system information block of the SSBs 215 for the sub-band 225-c.

In some examples, the UE 115-a may transmit the first random access message on the sub-band 225-c, but may transmit the second random access message on a different sub-band 225, such as the sub-band 225-b. In this case, the UE may not have access to information about uplink path loss on the sub-band 225-b, since uplink path loss may be sub-band dependent (e.g., frequency selective). In some examples, parts of the initial access procedure and the uplink PRACH power control procedure may be performed on an entire available bandwidth or an entire component carrier (e.g., wideband initial access). That is, the network entity 105-a may transmit SSBs 215 over an entire component carrier or an entire available bandwidth of a component carrier and the UE may transmit the first random access message over the entire component carrier or the entire available bandwidth of the component carrier, such that an uplink transmit power 250 determination may not be specific to a sub-band 225. The remaining initial access procedures (e.g., transmission of the random access message 2, random access message 3, and random access message 4), such as the PRACH power control procedure, may be performed on a sub-band 225.

In some examples, the UE 115-a and the network entity 105-a may perform wide-band PRACH transmit power determination. In such examples, the UE 115-a may receive SSB(s) 215 over an entire available bandwidth of a component carrier and may perform PRACH with a pre-configured uplink transmit power indicated by the first system information block of the SSB(s) 215 for the available bandwidth. In some cases, the UE 115-a may choose a preamble sequence, and may transmit a first random access message (e.g., PRACH Message 1) with an uplink transmit power 250 (e.g., P₀) indicated by the first system information block of the SSB 215. The first random access message may be an example of a message 220. In some examples, since the UE 115-a may not have access to information about the uplink path loss, the first uplink transmit power may not be sufficient for the network entity 105-a to obtain the first random access message. That is, the first uplink transmit power may not compensate for both the target reception power for the first random access message (e.g., the TargetPRACHRxPower) and the uplink path loss. In some cases, the UE 115-a may measure the downlink path loss based on the SSB 215 as a starting point for determining if the first uplink transmit power 250-c may be enough. In some cases, a power ramping procedure may be used to update the uplink transmit power 250-c.

After obtaining the first random access message over the available bandwidth an uplink transmit power, the network entity 105-a may measure the uplink path loss for sub-bands 225 of the available bandwidth. Then, the network entity 105-a may output random access response messages (e.g., PRACH Message 2) to the UE 115-a via each of the sub-band 225-c, where the random access response messages may indicate the uplink path loss for the corresponding sub-band 225. That is the network entity 105-a may signal the uplink path loss for a sub-band 225, such as sub-band 225-c, to the UE 115-a in the random access response message. Once the UE 115-a receives the indication of the uplink path loss over the sub-band 225-c, the UE 115-a may compensate for the uplink path loss. That is, the UE 115-a may transmit a second random access message (e.g., PRACH Message 3) with a third uplink transmit power 250-c on the sub-band 225-c that may account for the uplink path loss and a target reception power for a preamble (e.g., as indicated by a parameter such as PREAMBLE_RECEIVED_TARGET_POWER). For example, the UE 115-a may increase the uplink transmit power 250 to account for the uplink path loss such that the second random access message may be received at the target reception power. In some examples, the target reception power for the preamble may be sub-band specific and may be determined through a power ramping procedure. That is, the target reception power for the preamble may be determined based on a step value (e.g., a ramping parameter) and the indicated target reception power (e.g., preambleReceivedTargetPower), where both of the latter parameters may be indicated via the first system information block of the SSBs 215 for the sub-band 225-c.

In some implementations, as discussed above, a power ramping procedure (e.g., PREAMBLE_POWER_RAMPING_STEP) may be used to determine a desired uplink transmit power 250 for a sub-band 225. For example, the network entity 105-a may not obtain the first random access message with a first uplink transmit power. In response, the UE 115-a may transmit a repetition of the first random access message using an increased second uplink transmit power 250. The increased second uplink transmit power 250 may be the first uplink transmit power 250 increased by a step value, which may be indicated by the network entity 105-a in the first system information block of the SSB(s) 215. The step value for the power ramping procedure may be determined for each sub-band 225. In some cases, the network entity 105-a may obtain the repetition of the first random access message according to the second uplink transmit power (e.g., after the power has ramped). In other cases, the network entity 105-a may not receive the repetition of the access message according to the second uplink transmit power. In these cases, the UE 115-a may increase the second uplink transmit power by the step value again and transmit another repetition of the first random access message according to the increased second uplink transmit power 250. The UE 115-a may repeat this process until a repetition of the first random access message may be obtained at the network entity 105-a. In some cases, the network entity 105-a may indicate to the UE 115-a that the first random access message has been obtained. The indication may include the network entity 105-a outputting a random access response message, as described further at 225.

In some cases, the UE 115-a may select a new sub-band for use during the PRACH procedure. For example, the UE 115-a may transmit the first random access message on a sub-band 225-a. The UE 115-a may then switch to the sub-band 225-c to transmit the second random access message. That is, the UE 115-a may switch from a sub-band 225-a to sub-band 225-c, where the sub-band 225-a may be associated with a second uplink transmit power 250-a determined by the power ramping procedure using the step value, as described herein. In some cases, the UE 115-a may maintain the power ramping status and may use the second uplink transmit power 250-a as a starting value to perform a power ramping procedure at the sub-band 225-c. That is, the UE 115-a may carry over the power ramping status between sub-bands 225. In other cases, the UE 115-a may reset the power ramping status when switching from the sub-band 225-a to the sub-band 225-c. Determining whether to carry over or reset the power ramping status may be configured by the network entity 105-a (e.g., via RRC signaling). Additionally, or alternatively, whether to carry over or reset the power ramping status may be indicated on the first system information block of the SSB(s) 215.

In some cases, a reference signal to measure uplink and downlink path loss may be used to address the frequency selectivity and link direction dependency of the channel. This may be used in both open loop and closed loop uplink power control procedures. This process may be complementary to the open loop uplink power control procedure for low-pass channels described herein.

The techniques described herein may be applied to any strong low-pass channel with little to no fading, including but not limited to OWC channels. This may allow the use of operating bandwidths that may be relatively wider than those used in radio frequency solutions. In some cases, wide or very wide bandwidth channels may present low-pass behavior that may use open loop uplink power control as described herein.

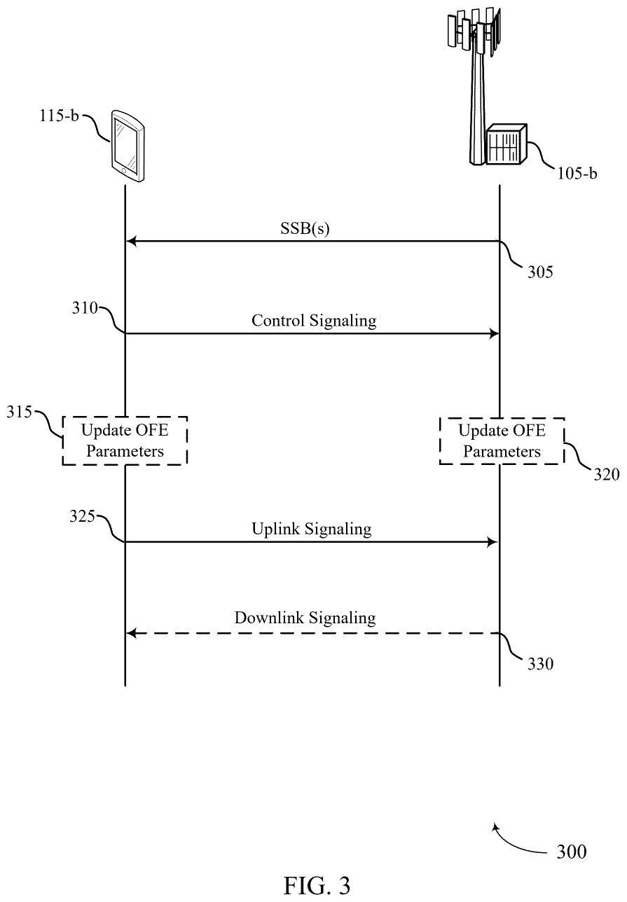

FIG. 3 shows an example of a process flow 300 that supports open loop uplink power control in low-pass channels in accordance with one or more aspects of the present disclosure. The process flow 300 may implement or be implemented to realize aspects of the wireless communications systems 100 or 200. For example, the process flow 300 illustrates communication between a UE 115-b and a network entity 105-b, which may be examples of corresponding devices described herein, including with reference to FIG. 1 and FIG. 2. The process flow 300 may provide for power control through calibration at the network entity 105-b and calibration at the UE 115-b to improve strong low-pass channel communications such that the network entity 105-b and the UE 115-b may have similar path loss for uplink communication and downlink communication.

At 305, the UE 115-b may receive, and the network entity 105-b may output, one or more SSBs indicating an uplink transmit power and a first set of OFE parameters associated with a network entity. In some implementations, the UE 115-b may receive broadcast signaling indicating a set of candidate OFE parameters, a set of candidate transmit powers, or both (e.g., via broadcast signaling prior to the SSBs or in a first SIB of the SSBs), where the SSB(s) may include an indication of the uplink transmit power from the set of candidate transmit powers an indication of the first set of OFE parameters from the set of candidate OFE parameters, or both. In some implementations, the SSB(s) may be received via an available bandwidth of at least one component carrier. In such implementations, the UE 115-b may receive, via the SSB(s), system information indicating a transmit power for control signaling, where transmitting the control signaling may be based on the indicated transmit power, as further described at 310. In other implementations, the SSB(s) may be received via multiple sub-bands, where an available bandwidth of at least one component carrier may be divided into the multiple sub-bands, and where the control signaling may be transmitted via a first sub-band of the multiple sub-bands. That is, the network entity 105-b may output SSB(s) via multiple sub-bands, where the SSB corresponding to the sub-band may include sub-band specific information. In some cases, the UE 115-b may select the first sub-band from the multiple sub-bands based on a quantity of UEs 115 in a cell associated with the first sub-band, where transmitting the control signaling via the first sub-band of the multiple sub-bands (e.g., at 310) may be based on selecting the first sub-band.

At 310, the UE 115-b may transmit, and the network entity 105-b may obtain, based on the SSB(s), the control signaling according to the uplink transmit power, where the control signaling may indicate a second set of optical front-end parameters associated with the UE 115-b. In some implementations, the control signaling may be transmitted via the available bandwidth of the component carrier. In other implementations, the control signaling may be transmitted via the first sub-band of the multiple sub-bands.

In some implementations, at 315, the UE 115-b may update parameters from an initial set of parameters to updated parameters, where the updated parameters include an updated transmit power for uplink signaling at 325.

In some implementations, at 320, the network entity 105-b may update second parameters from a second initial set of parameters to second updated parameters, where the second updated parameters include an updated transmit power for downlink signaling at 330.

At 325, the UE 115-b may transmit, and the network entity 105-b may obtain, the uplink signaling according to the updated parameters based on the first set of optical front-end parameters associated with the network entity 105-b. In some implementations, the uplink signaling may be transmitted via the available bandwidth of the component carrier according to the first set of OFE parameters. In other implementations, the uplink signaling may be transmitted via the first sub-band according to the first set of OFE parameters, as described further at 305. In some cases, transmitting the uplink signaling may include transmitting a first random access message, including a preamble, based on a calibration at the UE 115-b for uplink transmissions according to the updated parameters. Additionally, or alternatively, the UE 115-b may transmit a second random access message based on the calibration and based on receiving a random access response message, where receiving the random access response message may be based on transmitting the first random access message.

In some implementations, at 330, the UE 115-b may receive, and the network entity 105-b may output, downlink signaling based on transmitting the control signaling indicating the second set of OFE parameters. In some cases, the downlink signaling may include the network entity 105-b outputting the first random access response message based on a second calibration at the network entity 105-b for downlink transmissions according to the second updated parameters and based on obtaining the first random access message including a preamble. Additionally, or alternatively, the network entity 105-b may output a second random access response message based on the second calibration and based on obtaining the second random access message, where obtaining the second random access message may be based on outputting the first random access response message.

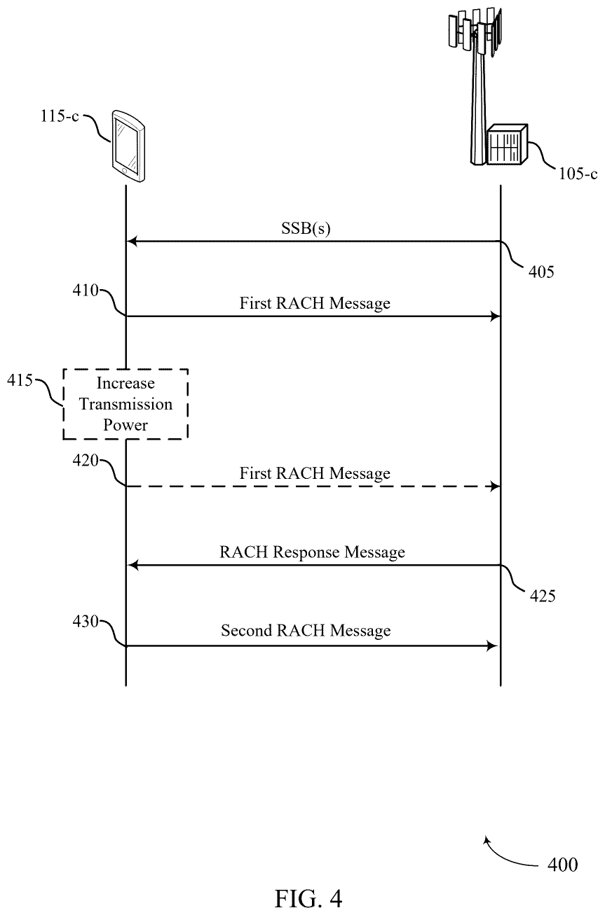

FIG. 4 shows an example of a process flow 400 that supports open loop uplink power control in low-pass channels in accordance with one or more aspects of the present disclosure. The process flow 400 may implement or be implemented to realize aspects of the wireless communications systems 100 or 200. For example, the process flow 400 illustrates communication between a UE 115-c and a network entity 105-c, which may be examples of corresponding devices described herein, including with reference to FIG. 1 and FIG. 2. The process flow 400 may support the UE 115-c calibrating an uplink transmit power, to account for uplink path loss, at the beginning of a PRACH process by updating an uplink transmit power based on an indication of the uplink path loss from the network entity 105-c.

At 405, the UE 115-c may receive, and the network entity 105-c may output, one or more SSBs indicating a first uplink transmit power and a target uplink reception power. In some cases, the UE 115-c may measure a downlink path loss based on receiving the SSB(s), where the second uplink transmit power may be based on the downlink path loss. In some implementations, the SSB(s) may be received via multiple sub-bands, where an available bandwidth of at least one component carrier may be divided into the multiple sub-bands, and where the first random access message may be transmitted via a first sub-band of the multiple sub-bands at 410. That is, the network entity 105-c may output SSB(s) to multiple sub-bands, where the SSB corresponding to the sub-band may include sub-band specific information (e.g., narrowband). In other implementations, the SSBs may be received at the UE 115-c via an available bandwidth of the component carrier(s) and a first random access message, as described further at 410, may be transmitted by the UE 115-c via the available bandwidth of the component carrier (e.g., wideband). In some cases, the available bandwidth of the component carrier may be divided into multiple sub-bands and the UE 115-c may receive a random access response message via a sub-band, as described further at 425. In some examples, the UE 115-c may select the sub-band from the multiple sub-bands based on the uplink path loss and the second target uplink reception power.

At 410, the UE 115-c may transmit a first random access message (e.g., first RACH message), including a preamble, according to a second uplink transmit power, where the second uplink transmit power may be based on the first uplink transmit power. In some cases, the network entity 105-c may obtain the first random access message, including a preamble, according to a second uplink transmit power. In some cases, the first uplink transmit power and the second uplink transmit power may be the same. In some cases, the UE 115-c may select a preamble sequence, where transmitting the first random access message may be based on the preamble sequence.

At 415, in some examples, the UE 115-c may increase the second uplink transmit power according to a step value, where the step value may be indicated in the SSB(s), as described further at 405.

At 420, in some examples, the UE 115-c may transmit a repetition of the first random access message according to the increased second uplink transmit power. For example, the UE 115-c may transmit the repetition of the first random access message because the network entity 105-c may not obtain the first random access message. In some cases, the network entity 105-c may obtain the repetition of the first random access message according to the increased second uplink transmit power (e.g., power ramping). In other cases, the network entity 105-c may not receive the repetition of the access message according to the increased second uplink transmit power. In these cases, the UE 115-c may increase the increased second uplink transmit power by the step value and transmit another repetition of the first random access message according to the further increased second uplink transmit power and may repeat this process until a repetition of the first random access message may be obtained at the network entity 105-c. In some cases, the network entity 105-c may indicate to the UE 115-c that the first random access message has been obtained. The indication may include the network entity 105-c outputting a random access response message, as described further at 425. In some implementations, the UE 115-c may switch from a first sub-band of multiple sub-bands to a second sub-band of multiple sub-bands, where an available bandwidth of one or more component carriers may be divided into the multiple sub-bands. In these implementations, the UE 115-c may receive a second one or more SSBs, from the network entity 105-c, via the second sub-band, where the second SSB(s) may indicate a third uplink transmit power, a second target uplink reception power, and a second step value. In some cases, the UE 115-c may transmit a third random access message according to a fourth uplink transmit power, the fourth uplink transmit power based on the increased second uplink transmit power. Then, the UE 115-c may increase the fourth uplink transmit power according to the second step value and may transmit a repetition of the third random access message according to the increased third uplink transmit power. That is, the UE 115-c may use a transmit power related to the first sub-band to transmit the third random access message on the second sub-band. In other cases, the UE 115-c may transmit the third random access message according to the third uplink transmit power. The UE 115-c may increase the third uplink transmit power according to a second step value, the second step value indicated in the second SSBs, and then the UE 115-c may transmit a repetition of the third random access message according to the increased third uplink transmit power. That is, the UE 115-c may reset a transmit power with which to transmit the third random access message when switching from the first sub-band to the second sub-band.

At 425, the UE 115-c may receive, and the network entity 105-c may output, a random access response message (e.g., RACH response message) corresponding to the first random access message, the random access response message including an indication of an uplink path loss. In some cases, the random access response message, which may include a second target uplink reception power for a sub-band of multiple sub-bands, may be received by the UE 115-c via the sub-band, where the available bandwidth of the component carrier may be divided into the multiple sub-bands. In these cases, as described further at 430, the UE 115-c may transmit a second random access message via the sub-band according to the second target uplink reception power. In some examples, the UE 115-c may select the sub-band from the multiple sub-bands based on the uplink path loss and the second target uplink reception power.

At 430, the UE 115-c may transmit, and the network entity 105-c may obtain, a second random access message (e.g., second RACH message) according to a third uplink transmit power, where the third uplink transmit power may be based on the uplink path loss and the target uplink reception power.

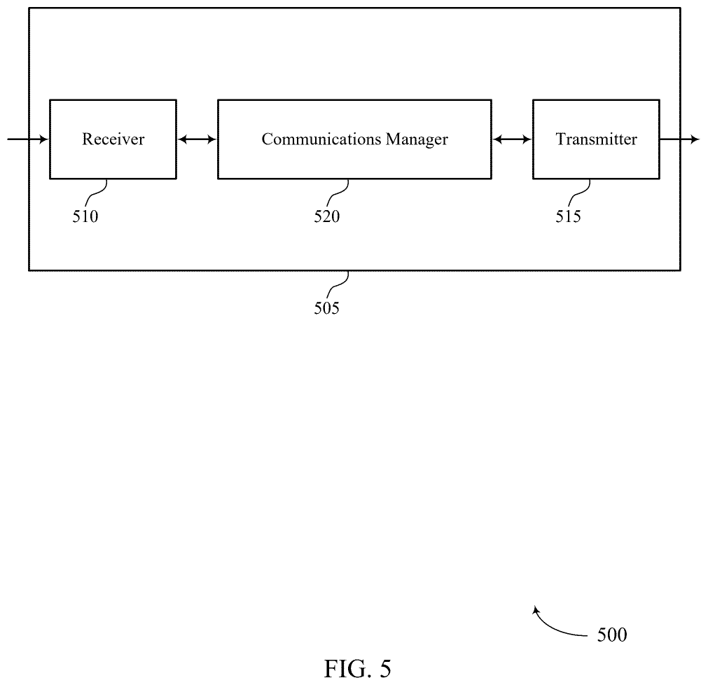

FIG. 5 shows a block diagram 500 of a device 505 that supports open loop uplink power control in low-pass channels in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to open loop uplink power control in low-pass channels). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to open loop uplink power control in low-pass channels). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of open loop uplink power control in low-pass channels as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. For example, the communications manager 520 is capable of, configured to, or operable to support a means for receiving one or more SSBs indicating an uplink transmit power and a first set of optical front-end parameters associated with a network entity. The communications manager 520 is capable of, configured to, or operable to support a means for transmitting, based on the one or more SSBs, control signaling according to the uplink transmit power, where the control signaling indicates a second set of optical front-end parameters associated with the UE. The communications manager 520 is capable of, configured to, or operable to support a means for transmitting uplink signaling according to one or more updated parameters based on the first set of optical front-end parameters associated with the network entity.

Additionally, or alternatively, the communications manager 520 may support wireless communication in accordance with examples as disclosed herein. For example, the communications manager 520 is capable of, configured to, or operable to support a means for receiving one or more SSBs indicating a first uplink transmit power and a target uplink reception power. The communications manager 520 is capable of, configured to, or operable to support a means for transmitting a first random access message, including a preamble, according to a second uplink transmit power, where the second uplink transmit power is based on the first uplink transmit power. The communications manager 520 is capable of, configured to, or operable to support a means for receiving a random access response message corresponding to the first random access message, the random access response message including an indication of an uplink path loss. The communications manager 520 is capable of, configured to, or operable to support a means for transmitting a second random access message according to a third uplink transmit power, where the third uplink transmit power is based on the uplink path loss and the target uplink reception power.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources, increased data throughput and broader access to more communication resources, and lower cost of fabrication.

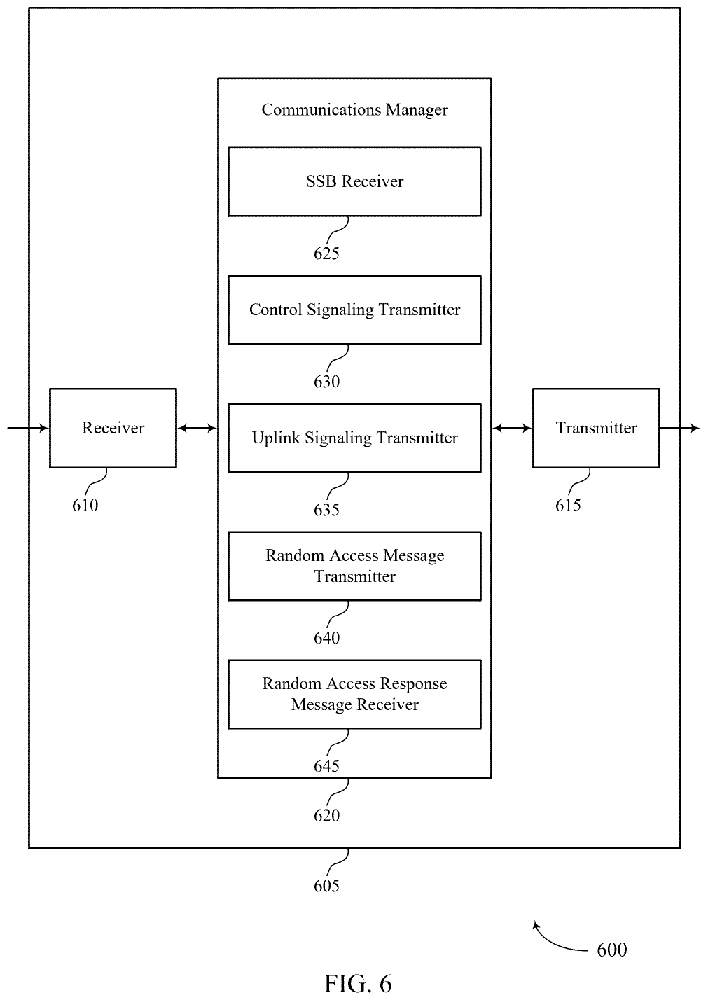

FIG. 6 shows a block diagram 600 of a device 605 that supports open loop uplink power control in low-pass channels in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to open loop uplink power control in low-pass channels). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to open loop uplink power control in low-pass channels). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of open loop uplink power control in low-pass channels as described herein. For example, the communications manager 620 may include an SSB receiver 625, a control signaling transmitter 630, an uplink signaling transmitter 635, a random access message transmitter 640, a random access response message receiver 645, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. The SSB receiver 625 is capable of, configured to, or operable to support a means for receiving one or more SSBs indicating an uplink transmit power and a first set of optical front-end parameters associated with a network entity. The control signaling transmitter 630 is capable of, configured to, or operable to support a means for transmitting, based on the one or more SSBs, control signaling according to the uplink transmit power, where the control signaling indicates a second set of optical front-end parameters associated with the UE. The uplink signaling transmitter 635 is capable of, configured to, or operable to support a means for transmitting uplink signaling according to one or more updated parameters based on the first set of optical front-end parameters associated with the network entity.

Additionally, or alternatively, the communications manager 620 may support wireless communication in accordance with examples as disclosed herein. The SSB receiver 625 is capable of, configured to, or operable to support a means for receiving one or more SSBs indicating a first uplink transmit power and a target uplink reception power. The random access message transmitter 640 is capable of, configured to, or operable to support a means for transmitting a first random access message, including a preamble, according to a second uplink transmit power, where the second uplink transmit power is based on the first uplink transmit power. The random access response message receiver 645 is capable of, configured to, or operable to support a means for receiving a random access response message corresponding to the first random access message, the random access response message including an indication of an uplink path loss. The random access message transmitter 640 is capable of, configured to, or operable to support a means for transmitting a second random access message according to a third uplink transmit power, where the third uplink transmit power is based on the uplink path loss and the target uplink reception power.

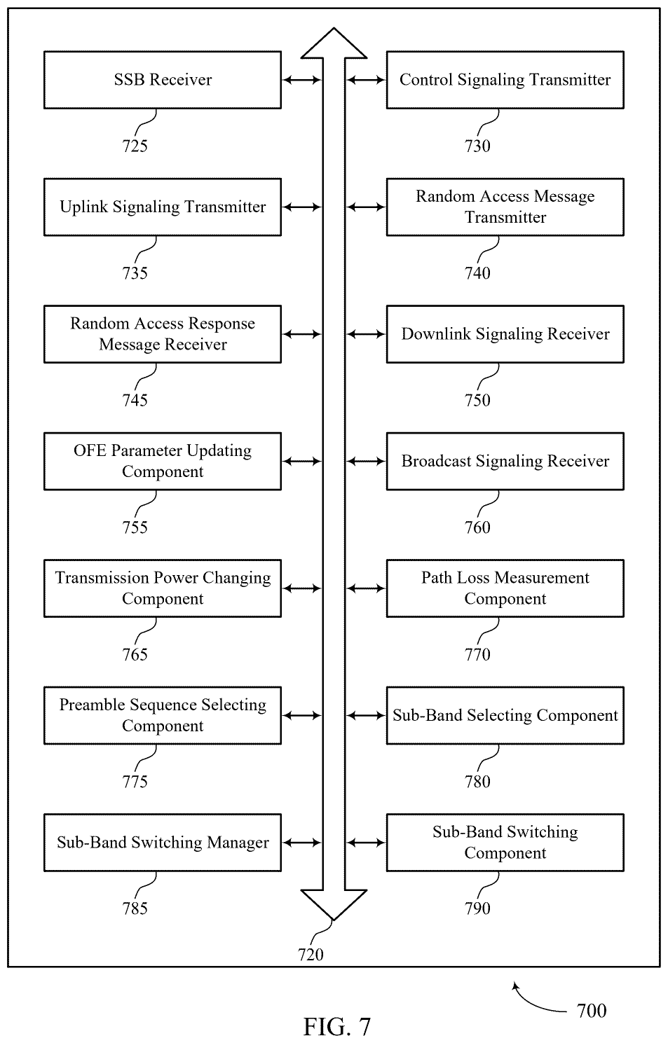

FIG. 7 shows a block diagram 700 of a communications manager 720 that supports open loop uplink power control in low-pass channels in accordance with one or more aspects of the present disclosure. The communications manager 720 may be an example of aspects of a communications manager 520, a communications manager 620, or both, as described herein. The communications manager 720, or various components thereof, may be an example of means for performing various aspects of open loop uplink power control in low-pass channels as described herein. For example, the communications manager 720 may include an SSB receiver 725, a control signaling transmitter 730, an uplink signaling transmitter 735, a random access message transmitter 740, a random access response message receiver 745, a downlink signaling receiver 750, a OFE parameter updating component 755, a broadcast signaling receiver 760, a transmit power changing component 765, a path loss measurement component 770, a preamble sequence selecting component 775, a sub-band selecting component 780, a sub-band switching manager 785, a sub-band switching component 790, or any combination thereof. Each of these components, or components or subcomponents thereof (e.g., one or more processors, one or more memories), may communicate, directly or indirectly, with one another (e.g., via one or more buses).

The communications manager 720 may support wireless communication in accordance with examples as disclosed herein. The SSB receiver 725 is capable of, configured to, or operable to support a means for receiving one or more SSBs indicating an uplink transmit power and a first set of optical front-end parameters associated with a network entity. The control signaling transmitter 730 is capable of, configured to, or operable to support a means for transmitting, based on the one or more SSBs, control signaling according to the uplink transmit power, where the control signaling indicates a second set of optical front-end parameters associated with the UE. The uplink signaling transmitter 735 is capable of, configured to, or operable to support a means for transmitting uplink signaling according to one or more updated parameters based on the first set of optical front-end parameters associated with the network entity.

In some examples, the downlink signaling receiver 750 is capable of, configured to, or operable to support a means for receiving downlink signaling based on transmitting the control signaling that indicates the second set of optical front-end parameters.

In some examples, the OFE parameter updating component 755 is capable of, configured to, or operable to support a means for updating one or more parameters from an initial set of one or more parameters to the one or more updated parameters, where the one or more updated parameters include an updated transmit power for the uplink signaling.

In some examples, the one or more SSBs are received via an available bandwidth of at least one component carrier and. In some examples, the control signaling is transmitted via the available bandwidth of the at least one component carrier.

In some examples, the SSB receiver 725 is capable of, configured to, or operable to support a means for receiving via the one or more SSBs, system information indicating a transmit power for the control signaling, where in transmitting the control signaling is based on the indicated transmit power.

In some examples, the uplink signaling is transmitted via the available bandwidth of the at least one component carrier according to the first set of optical front-end parameters.

In some examples, the one or more SSBs are received via a set of multiple sub-bands. In some examples, an available bandwidth of at least one component carrier is divided into the set of multiple sub-bands. In some examples, the control signaling is transmitted via a first sub-band of the set of multiple sub-bands.

In some examples, the sub-band selecting component 780 is capable of, configured to, or operable to support a means for selecting the first sub-band from the set of multiple sub-bands based on a quantity of UEs in a cell associated with the first sub-band, where transmitting the control signaling via the first sub-band of the set of multiple sub-bands is based on the selecting.

In some examples, the uplink signaling is transmitted via the first sub-band according to the first set of optical front-end parameters.

In some examples, the broadcast signaling receiver 760 is capable of, configured to, or operable to support a means for receiving broadcast signaling indicating a set of candidate optical front-end parameters, a set of candidate transmit powers, or both, where the one or more SSBs include an indication of the uplink transmit power from the set of candidate transmit powers, an indication of the first set of optical front-end parameters from the set of candidate optical front-end parameters, or both.

In some examples, to support transmitting the uplink signaling according to the one or more updated parameters, the random access message transmitter 740 is capable of, configured to, or operable to support a means for transmitting a first random access message, including a preamble, based on a calibration at the UE for uplink transmissions according to the one or more updated parameters. In some examples, to support transmitting the uplink signaling according to the one or more updated parameters, the random access message transmitter 740 is capable of, configured to, or operable to support a means for transmitting a second random access message based on the calibration and based on receiving a random access response message, where receiving the random access response message is based on transmitting the first random access message.

Additionally, or alternatively, the communications manager 720 may support wireless communication in accordance with examples as disclosed herein. In some examples, the SSB receiver 725 is capable of, configured to, or operable to support a means for receiving one or more SSBs indicating a first uplink transmit power and a target uplink reception power. The random access message transmitter 740 is capable of, configured to, or operable to support a means for transmitting a first random access message, including a preamble, according to a second uplink transmit power, where the second uplink transmit power is based on the first uplink transmit power. The random access response message receiver 745 is capable of, configured to, or operable to support a means for receiving a random access response message corresponding to the first random access message, the random access response message including an indication of an uplink path loss. In some examples, the random access message transmitter 740 is capable of, configured to, or operable to support a means for transmitting a second random access message according to a third uplink transmit power, where the third uplink transmit power is based on the uplink path loss and the target uplink reception power.

In some examples, the transmit power changing component 765 is capable of, configured to, or operable to support a means for increasing the second uplink transmit power according to a step value, the step value indicated in the one or more SSBs. In some examples, the random access message transmitter 740 is capable of, configured to, or operable to support a means for transmitting a repetition of the first random access message according to the increased second uplink transmit power.

In some examples, the sub-band switching manager 785 is capable of, configured to, or operable to support a means for switching from a first sub-band of a set of multiple sub-bands to a second sub-band of the set of multiple sub-bands, where an available bandwidth of at least one component carrier is divided into the set of multiple sub-bands. In some examples, the SSB receiver 725 is capable of, configured to, or operable to support a means for receiving a second one or more SSBs via the second sub-band, where the second one or more SSBs indicates a third uplink transmit power, a second target uplink reception power, and a second step value. In some examples, the random access message transmitter 740 is capable of, configured to, or operable to support a means for transmitting a third random access message according to a fourth uplink transmit power, the fourth uplink transmit power based on the increased second uplink transmit power. In some examples, the transmit power changing component 765 is capable of, configured to, or operable to support a means for increasing the fourth uplink transmit power according to the second step value. In some examples, the random access message transmitter 740 is capable of, configured to, or operable to support a means for transmitting a repetition of the third random access message according to the increased third uplink transmit power.

In some examples, the sub-band switching component 790 is capable of, configured to, or operable to support a means for switching from a first sub-band of a set of multiple sub-bands to a second sub-band of the set of multiple sub-bands, where an available bandwidth of at least one component carrier is divided into the set of multiple sub-bands. In some examples, the SSB receiver 725 is capable of, configured to, or operable to support a means for receiving a second one or more SSBs via the second sub-band, where the second one or more SSBs indicates a third uplink transmit power, a second target uplink reception power, and a second step value. In some examples, the random access message transmitter 740 is capable of, configured to, or operable to support a means for transmitting a third random access message according to the third uplink transmit power. In some examples, the transmit power changing component 765 is capable of, configured to, or operable to support a means for increasing the third uplink transmit power according to a second step value, the second step value indicated in the second one or more SSBs. In some examples, the random access message transmitter 740 is capable of, configured to, or operable to support a means for transmitting a repetition of the third random access message according to the increased third uplink transmit power.

In some examples, the path loss measurement component 770 is capable of, configured to, or operable to support a means for measuring a downlink path loss based on receiving the one or more SSBs, where the second uplink transmit power is based on the downlink path loss.

In some examples, the one or more SSBs are received via a set of multiple sub-bands. In some examples, an available bandwidth of at least one component carrier is divided into the set of multiple sub-bands. In some examples, the first random access message is transmitted via a first sub-band of the set of multiple sub-bands.

In some examples, the one or more SSBs are received via an available bandwidth of at least one component carrier and. In some examples, the random access message is transmitted via the available bandwidth of the at least one component carrier.

In some examples, the random access response message, including a second target uplink reception power for a sub-band of a set of multiple sub-bands, is received via the sub-band. In some examples, the available bandwidth of the at least one component carrier is divided into the set of multiple sub-bands. In some examples, the second random access message is transmitted via the sub-band according to the second target uplink reception power.

In some examples, the sub-band selecting component 780 is capable of, configured to, or operable to support a means for selecting the sub-band from the set of multiple sub-bands based on the uplink path loss and the second target uplink reception power.

In some examples, the first uplink transmit power and the second uplink transmit power are the same.

In some examples, the preamble sequence selecting component 775 is capable of, configured to, or operable to support a means for selecting a preamble sequence, where transmitting the first random access message is based on the preamble sequence.

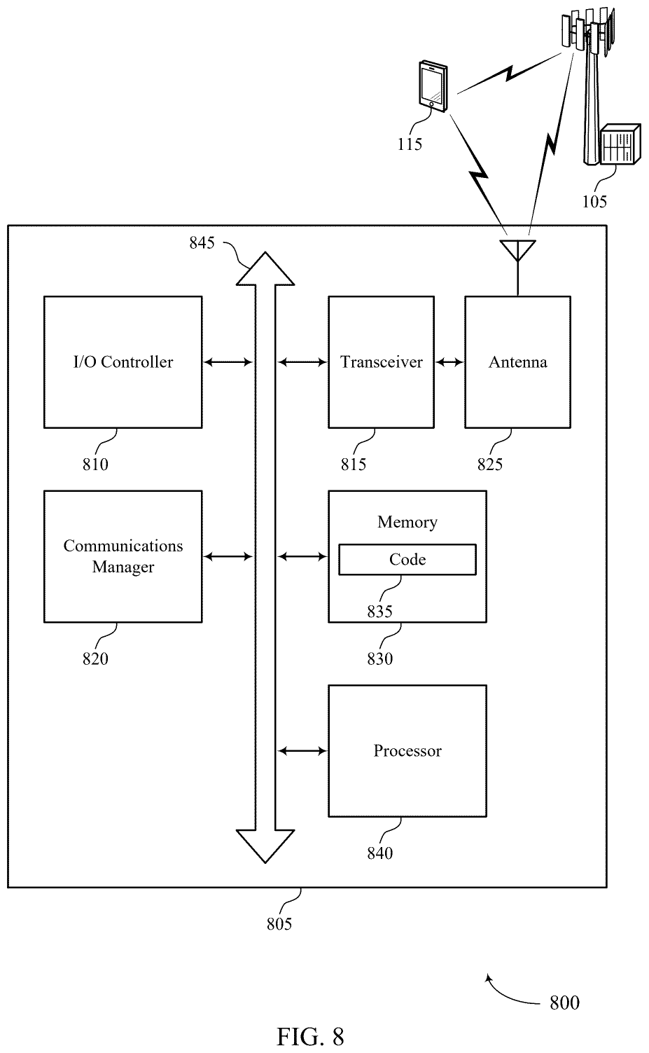

FIG. 8 shows a diagram of a system 800 including a device 805 that supports open loop uplink power control in low-pass channels in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting open loop uplink power control in low-pass channels). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communication in accordance with examples as disclosed herein. For example, the communications manager 820 is capable of, configured to, or operable to support a means for receiving one or more SSBs indicating an uplink transmit power and a first set of optical front-end parameters associated with a network entity. The communications manager 820 is capable of, configured to, or operable to support a means for transmitting, based on the one or more SSBs, control signaling according to the uplink transmit power, where the control signaling indicates a second set of optical front-end parameters associated with the UE. The communications manager 820 is capable of, configured to, or operable to support a means for transmitting uplink signaling according to one or more updated parameters based on the first set of optical front-end parameters associated with the network entity.

Additionally, or alternatively, the communications manager 820 may support wireless communication in accordance with examples as disclosed herein. For example, the communications manager 820 is capable of, configured to, or operable to support a means for receiving one or more SSBs indicating a first uplink transmit power and a target uplink reception power. The communications manager 820 is capable of, configured to, or operable to support a means for transmitting a first random access message, including a preamble, according to a second uplink transmit power, where the second uplink transmit power is based on the first uplink transmit power. The communications manager 820 is capable of, configured to, or operable to support a means for receiving a random access response message corresponding to the first random access message, the random access response message including an indication of an uplink path loss. The communications manager 820 is capable of, configured to, or operable to support a means for transmitting a second random access message according to a third uplink transmit power, where the third uplink transmit power is based on the uplink path loss and the target uplink reception power.

By including or configuring the communications manager 820 in accordance with examples as described herein, the device 805 may support techniques for more efficient utilization of communication resources, increased data throughput and broader access to more communication resources, improved user experience related to reduced processing, and lower cost of fabrication.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of open loop uplink power control in low-pass channels as described herein, or the at least one processor 840 and the at least one memory 830 may be otherwise configured to, individually or collectively, perform or support such operations.

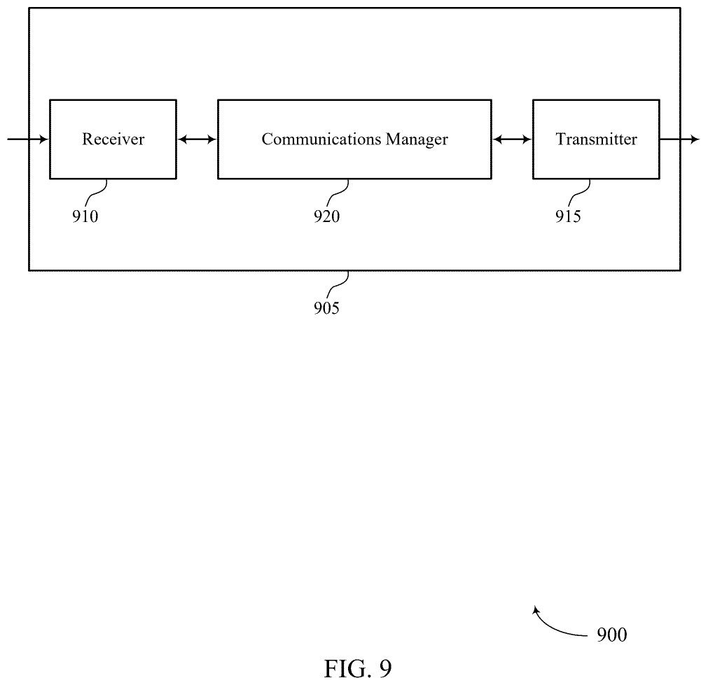

FIG. 9 shows a block diagram 900 of a device 905 that supports open loop uplink power control in low-pass channels in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of open loop uplink power control in low-pass channels as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. For example, the communications manager 920 is capable of, configured to, or operable to support a means for outputting one or more SSBs indicating an uplink transmit power and a first set of optical front-end parameters associated with the network entity. The communications manager 920 is capable of, configured to, or operable to support a means for obtaining, based on the one or more SSBs, control signaling according to the uplink transmit power, where the control signaling indicates a second set of optical front-end parameters associated with a UE. The communications manager 920 is capable of, configured to, or operable to support a means for outputting downlink signaling according to one or more updated parameters based on the second set of optical front-end parameters associated with the UE.

Additionally, or alternatively, the communications manager 920 may support wireless communication in accordance with examples as disclosed herein. For example, the communications manager 920 is capable of, configured to, or operable to support a means for outputting one or more SSBs indicating a first uplink transmit power and a target uplink reception power. The communications manager 920 is capable of, configured to, or operable to support a means for obtaining a first random access message, including a preamble, according to a second uplink transmit power, where the second uplink transmit power is based on the first uplink transmit power. The communications manager 920 is capable of, configured to, or operable to support a means for outputting a random access response message corresponding to the first random access message, the random access response message including an indication of an uplink path loss. The communications manager 920 is capable of, configured to, or operable to support a means for obtaining a second random access message according to a third uplink transmit power, where the third uplink transmit power is based on the uplink path loss and the target uplink reception power.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for more efficient utilization of communication resources, increased data throughput and broader access to more communication resources, and lower cost of fabrication.

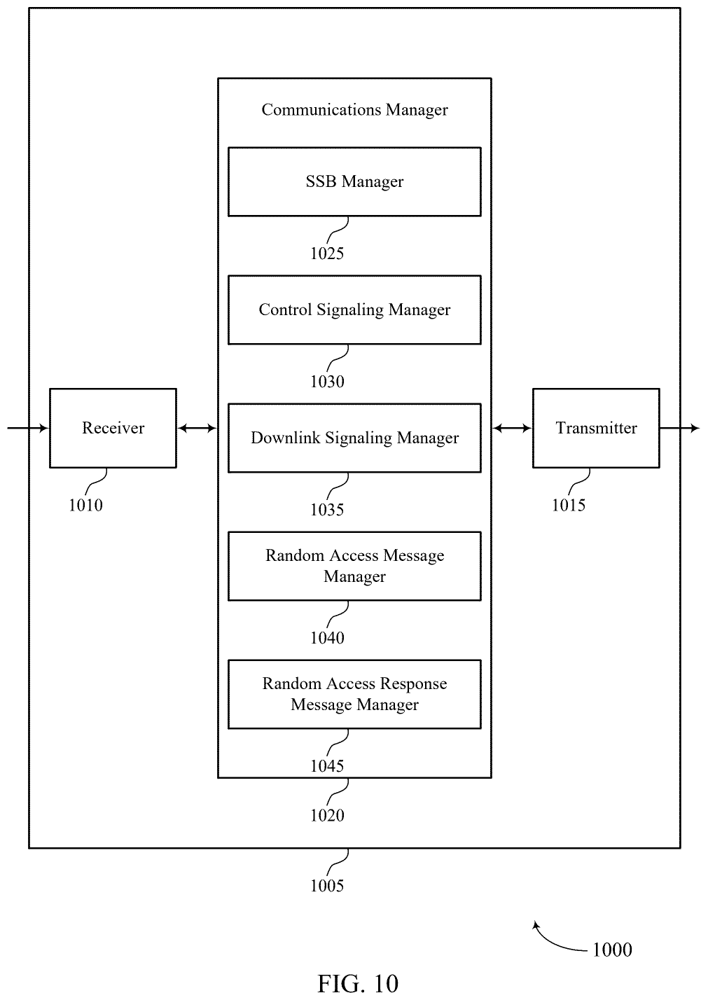

FIG. 10 shows a block diagram 1000 of a device 1005 that supports open loop uplink power control in low-pass channels in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of open loop uplink power control in low-pass channels as described herein. For example, the communications manager 1020 may include an SSB manager 1025, a control signaling manager 1030, a downlink signaling manager 1035, a random access message manager 1040, a random access response message manager 1045, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. The SSB manager 1025 is capable of, configured to, or operable to support a means for outputting one or more SSBs indicating an uplink transmit power and a first set of optical front-end parameters associated with the network entity. The control signaling manager 1030 is capable of, configured to, or operable to support a means for obtaining, based on the one or more SSBs, control signaling according to the uplink transmit power, where the control signaling indicates a second set of optical front-end parameters associated with a UE. The downlink signaling manager 1035 is capable of, configured to, or operable to support a means for outputting downlink signaling according to one or more updated parameters based on the second set of optical front-end parameters associated with the UE.

Additionally, or alternatively, the communications manager 1020 may support wireless communication in accordance with examples as disclosed herein. The SSB manager 1025 is capable of, configured to, or operable to support a means for outputting one or more SSBs indicating a first uplink transmit power and a target uplink reception power. The random access message manager 1040 is capable of, configured to, or operable to support a means for obtaining a first random access message, including a preamble, according to a second uplink transmit power, where the second uplink transmit power is based on the first uplink transmit power. The random access response message manager 1045 is capable of, configured to, or operable to support a means for outputting a random access response message corresponding to the first random access message, the random access response message including an indication of an uplink path loss. The random access message manager 1040 is capable of, configured to, or operable to support a means for obtaining a second random access message according to a third uplink transmit power, where the third uplink transmit power is based on the uplink path loss and the target uplink reception power.

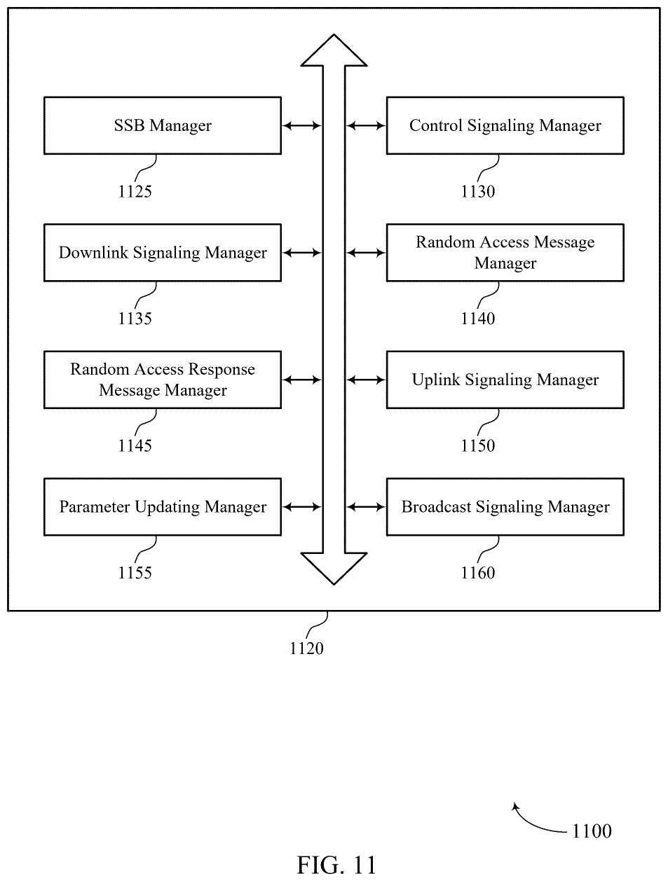

FIG. 11 shows a block diagram 1100 of a communications manager 1120 that supports open loop uplink power control in low-pass channels in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of open loop uplink power control in low-pass channels as described herein. For example, the communications manager 1120 may include an SSB manager 1125, a control signaling manager 1130, a downlink signaling manager 1135, a random access message manager 1140, a random access response message manager 1145, an uplink signaling manager 1150, a parameter updating manager 1155, a broadcast signaling manager 1160, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication in accordance with examples as disclosed herein. The SSB manager 1125 is capable of, configured to, or operable to support a means for outputting one or more SSBs indicating an uplink transmit power and a first set of optical front-end parameters associated with the network entity. The control signaling manager 1130 is capable of, configured to, or operable to support a means for obtaining, based on the one or more SSBs, control signaling according to the uplink transmit power, where the control signaling indicates a second set of optical front-end parameters associated with a UE. The downlink signaling manager 1135 is capable of, configured to, or operable to support a means for outputting downlink signaling according to one or more updated parameters based on the second set of optical front-end parameters associated with the UE.

In some examples, the uplink signaling manager 1150 is capable of, configured to, or operable to support a means for obtaining uplink signaling based on outputting the one or more SSBs that indicate the first set of optical front-end parameters.

In some examples, the parameter updating manager 1155 is capable of, configured to, or operable to support a means for updating one or more parameters from an initial set of one or more parameters to the one or more updated parameters, where the one or more updated parameters include an updated transmit power for the downlink signaling.

In some examples, the one or more SSBs are output via an available bandwidth of at least one component carrier and. In some examples, the control signaling is obtained via the available bandwidth of the at least one component carrier.

In some examples, the SSB manager 1125 is capable of, configured to, or operable to support a means for outputting, via the one or more SSBs, system information indicating a transmit power for the control signaling, where obtaining the control signaling is based on the indicated transmit power.

In some examples, the broadcast signaling manager 1160 is capable of, configured to, or operable to support a means for outputting broadcast signaling indicating a set of candidate optical front-end parameters, a set of candidate transmit powers, or both, where the one or more SSBs include an indication of the uplink transmit power from the set of candidate transmit powers, an indication of the first set of optical front-end parameters from the set of candidate optical front-end parameters, or both.

In some examples, to support outputting the downlink signaling according to the one or more updated parameters, the random access message manager 1140 is capable of, configured to, or operable to support a means for outputting a first random access response message based on a calibration at the network entity for downlink transmissions according to the one or more updated parameters and based on obtaining a first random access message including a preamble. In some examples, to support outputting the downlink signaling according to the one or more updated parameters, the random access message manager 1140 is capable of, configured to, or operable to support a means for outputting a second random access response message based on the calibration and based on obtaining a second random access message, where obtaining the second random access message is based on outputting the first random access response message.

Additionally, or alternatively, the communications manager 1120 may support wireless communication in accordance with examples as disclosed herein. In some examples, the SSB manager 1125 is capable of, configured to, or operable to support a means for outputting one or more SSBs indicating a first uplink transmit power and a target uplink reception power. The random access message manager 1140 is capable of, configured to, or operable to support a means for obtaining a first random access message, including a preamble, according to a second uplink transmit power, where the second uplink transmit power is based on the first uplink transmit power. The random access response message manager 1145 is capable of, configured to, or operable to support a means for outputting a random access response message corresponding to the first random access message, the random access response message including an indication of an uplink path loss. In some examples, the random access message manager 1140 is capable of, configured to, or operable to support a means for obtaining a second random access message according to a third uplink transmit power, where the third uplink transmit power is based on the uplink path loss and the target uplink reception power.

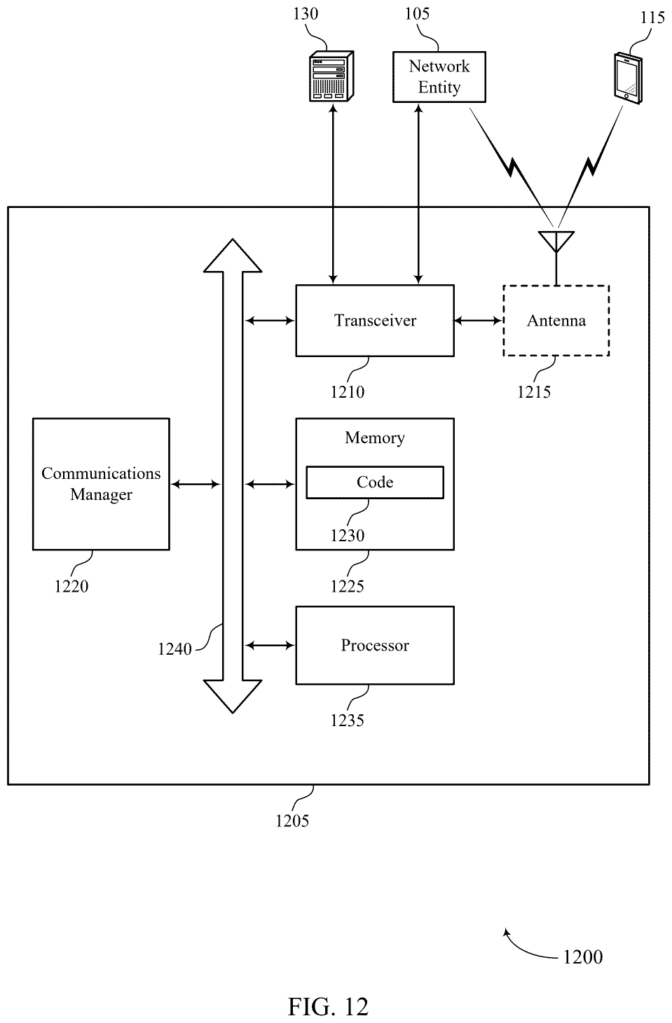

FIG. 12 shows a diagram of a system 1200 including a device 1205 that supports open loop uplink power control in low-pass channels in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting open loop uplink power control in low-pass channels). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communication in accordance with examples as disclosed herein. For example, the communications manager 1220 is capable of, configured to, or operable to support a means for outputting one or more SSBs indicating an uplink transmit power and a first set of optical front-end parameters associated with the network entity. The communications manager 1220 is capable of, configured to, or operable to support a means for obtaining, based on the one or more SSBs, control signaling according to the uplink transmit power, where the control signaling indicates a second set of optical front-end parameters associated with a UE. The communications manager 1220 is capable of, configured to, or operable to support a means for outputting downlink signaling according to one or more updated parameters based on the second set of optical front-end parameters associated with the UE.

Additionally, or alternatively, the communications manager 1220 may support wireless communication in accordance with examples as disclosed herein. For example, the communications manager 1220 is capable of, configured to, or operable to support a means for outputting one or more SSBs indicating a first uplink transmit power and a target uplink reception power. The communications manager 1220 is capable of, configured to, or operable to support a means for obtaining a first random access message, including a preamble, according to a second uplink transmit power, where the second uplink transmit power is based on the first uplink transmit power. The communications manager 1220 is capable of, configured to, or operable to support a means for outputting a random access response message corresponding to the first random access message, the random access response message including an indication of an uplink path loss. The communications manager 1220 is capable of, configured to, or operable to support a means for obtaining a second random access message according to a third uplink transmit power, where the third uplink transmit power is based on the uplink path loss and the target uplink reception power.

By including or configuring the communications manager 1220 in accordance with examples as described herein, the device 1205 may support techniques for more efficient utilization of communication resources, increased data throughput and broader access to more communication resources, improved user experience related to reduced processing, and lower cost of fabrication.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of open loop uplink power control in low-pass channels as described herein, or the at least one processor 1235 and the at least one memory 1225 may be otherwise configured to, individually or collectively, perform or support such operations.

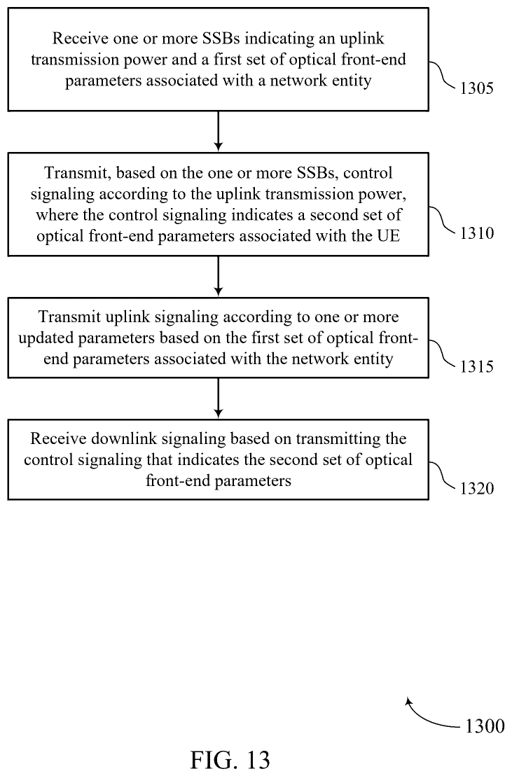

FIG. 13 shows a flowchart illustrating a method 1300 that supports open loop uplink power control in low-pass channels in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving one or more SSBs indicating an uplink transmit power and a first set of optical front-end parameters associated with a network entity. The operations of 1305 may be performed in accordance with examples as disclosed herein. In some examples, aspects of the operations of 1305 may be performed by an SSB receiver 725 as described with reference to FIG. 7.

At 1310, the method may include transmitting, based on the one or more SSBs, control signaling according to the uplink transmit power, where the control signaling indicates a second set of optical front-end parameters associated with the UE. The operations of 1310 may be performed in accordance with examples as disclosed herein. In some examples, aspects of the operations of 1310 may be performed by a control signaling transmitter 730 as described with reference to FIG. 7.

At 1315, the method may include transmitting uplink signaling according to one or more updated parameters based on the first set of optical front-end parameters associated with the network entity. The operations of 1315 may be performed in accordance with examples as disclosed herein. In some examples, aspects of the operations of 1315 may be performed by an uplink signaling transmitter 735 as described with reference to FIG. 7.

At 1320, the method may include receiving downlink signaling based on transmitting the control signaling that indicates the second set of optical front-end parameters. The operations of 1320 may be performed in accordance with examples as disclosed herein. In some examples, aspects of the operations of 1320 may be performed by a downlink signaling receiver 750 as described with reference to FIG. 7.

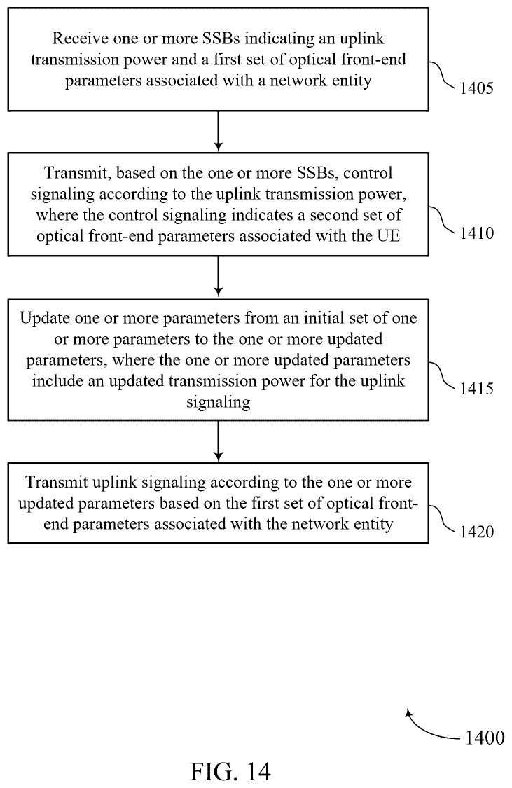

FIG. 14 shows a flowchart illustrating a method 1400 that supports open loop uplink power control in low-pass channels in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving one or more SSBs indicating an uplink transmit power and a first set of optical front-end parameters associated with a network entity. The operations of 1405 may be performed in accordance with examples as disclosed herein. In some examples, aspects of the operations of 1405 may be performed by an SSB receiver 725 as described with reference to FIG. 7.

At 1410, the method may include transmitting, based on the one or more SSBs, control signaling according to the uplink transmit power, where the control signaling indicates a second set of optical front-end parameters associated with the UE. The operations of 1410 may be performed in accordance with examples as disclosed herein. In some examples, aspects of the operations of 1410 may be performed by a control signaling transmitter 730 as described with reference to FIG. 7.

At 1415, the method may include updating one or more parameters from an initial set of one or more parameters to the one or more updated parameters, where the one or more updated parameters include an updated transmit power for the uplink signaling. The operations of 1415 may be performed in accordance with examples as disclosed herein. In some examples, aspects of the operations of 1415 may be performed by a OFE parameter updating component 755 as described with reference to FIG. 7.

At 1420, the method may include transmitting uplink signaling according to one or more updated parameters based on the first set of optical front-end parameters associated with the network entity. The operations of 1420 may be performed in accordance with examples as disclosed herein. In some examples, aspects of the operations of 1420 may be performed by an uplink signaling transmitter 735 as described with reference to FIG. 7.

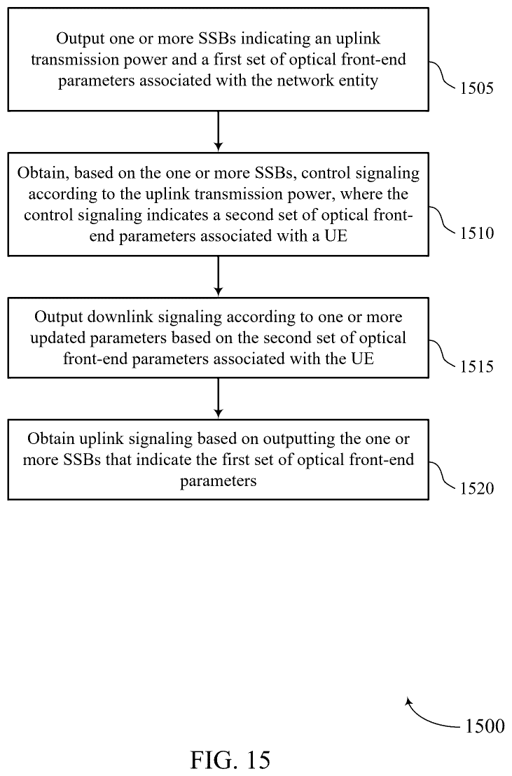

FIG. 15 shows a flowchart illustrating a method 1500 that supports open loop uplink power control in low-pass channels in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include outputting one or more SSBs indicating an uplink transmit power and a first set of optical front-end parameters associated with the network entity. The operations of 1505 may be performed in accordance with examples as disclosed herein. In some examples, aspects of the operations of 1505 may be performed by an SSB manager 1125 as described with reference to FIG. 11.

At 1510, the method may include obtaining, based on the one or more SSBs, control signaling according to the uplink transmit power, where the control signaling indicates a second set of optical front-end parameters associated with a UE. The operations of 1510 may be performed in accordance with examples as disclosed herein. In some examples, aspects of the operations of 1510 may be performed by a control signaling manager 1130 as described with reference to FIG. 11.

At 1515, the method may include outputting downlink signaling according to one or more updated parameters based on the second set of optical front-end parameters associated with the UE. The operations of 1515 may be performed in accordance with examples as disclosed herein. In some examples, aspects of the operations of 1515 may be performed by a downlink signaling manager 1135 as described with reference to FIG. 11.

At 1520, the method may include obtaining uplink signaling based on outputting the one or more SSBs that indicate the first set of optical front-end parameters. The operations of 1520 may be performed in accordance with examples as disclosed herein. In some examples, aspects of the operations of 1520 may be performed by an uplink signaling manager 1150 as described with reference to FIG. 11.

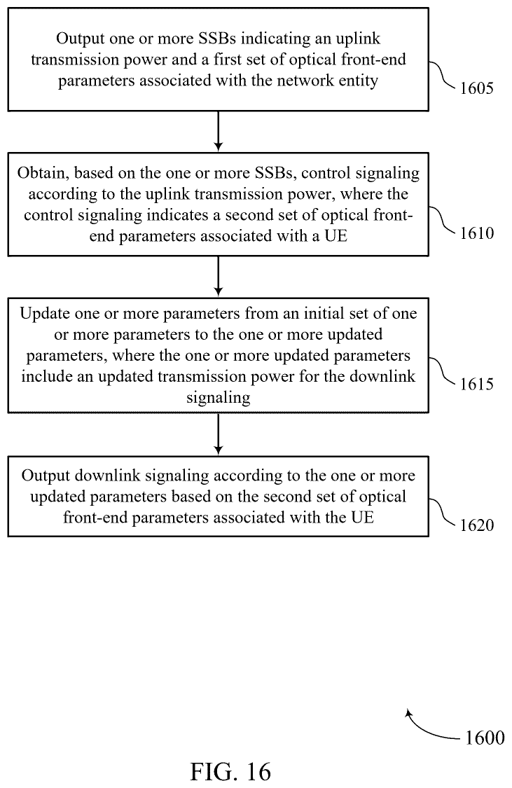

FIG. 16 shows a flowchart illustrating a method 1600 that supports open loop uplink power control in low-pass channels in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include outputting one or more SSBs indicating an uplink transmit power and a first set of optical front-end parameters associated with the network entity. The operations of 1605 may be performed in accordance with examples as disclosed herein. In some examples, aspects of the operations of 1605 may be performed by an SSB manager 1125 as described with reference to FIG. 11.

At 1610, the method may include obtaining, based on the one or more SSBs, control signaling according to the uplink transmit power, where the control signaling indicates a second set of optical front-end parameters associated with a UE. The operations of 1610 may be performed in accordance with examples as disclosed herein. In some examples, aspects of the operations of 1610 may be performed by a control signaling manager 1130 as described with reference to FIG. 11.

At 1615, the method may include updating one or more parameters from an initial set of one or more parameters to the one or more updated parameters, where the one or more updated parameters include an updated transmit power for the downlink signaling. The operations of 1615 may be performed in accordance with examples as disclosed herein. In some examples, aspects of the operations of 1615 may be performed by a parameter updating manager 1155 as described with reference to FIG. 11.

At 1620, the method may include outputting downlink signaling according to one or more updated parameters based on the second set of optical front-end parameters associated with the UE. The operations of 1620 may be performed in accordance with examples as disclosed herein. In some examples, aspects of the operations of 1620 may be performed by a downlink signaling manager 1135 as described with reference to FIG. 11.

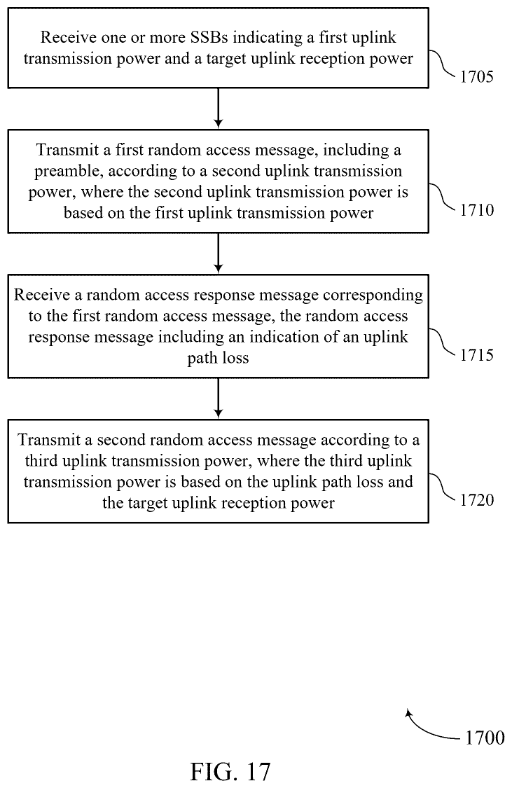

FIG. 17 shows a flowchart illustrating a method 1700 that supports open loop uplink power control in low-pass channels in accordance with one or more aspects of the present disclosure. The operations of the method 1700 may be implemented by a UE or its components as described herein. For example, the operations of the method 1700 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1705, the method may include receiving one or more SSBs indicating a first uplink transmit power and a target uplink reception power. The operations of 1705 may be performed in accordance with examples as disclosed herein. In some examples, aspects of the operations of 1705 may be performed by an SSB receiver 725 as described with reference to FIG. 7.

At 1710, the method may include transmitting a first random access message, including a preamble, according to a second uplink transmit power, where the second uplink transmit power is based on the first uplink transmit power. The operations of 1710 may be performed in accordance with examples as disclosed herein. In some examples, aspects of the operations of 1710 may be performed by a random access message transmitter 740 as described with reference to FIG. 7.

At 1715, the method may include receiving a random access response message corresponding to the first random access message, the random access response message including an indication of an uplink path loss. The operations of 1715 may be performed in accordance with examples as disclosed herein. In some examples, aspects of the operations of 1715 may be performed by a random access response message receiver 745 as described with reference to FIG. 7.

At 1720, the method may include transmitting a second random access message according to a third uplink transmit power, where the third uplink transmit power is based on the uplink path loss and the target uplink reception power. The operations of 1720 may be performed in accordance with examples as disclosed herein. In some examples, aspects of the operations of 1720 may be performed by a random access message transmitter 740 as described with reference to FIG. 7.

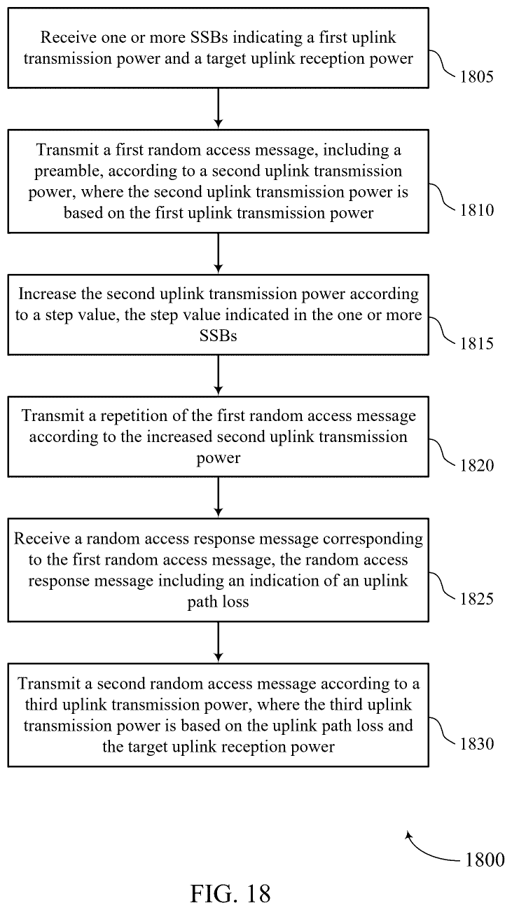

FIG. 18 shows a flowchart illustrating a method 1800 that supports open loop uplink power control in low-pass channels in accordance with one or more aspects of the present disclosure. The operations of the method 1800 may be implemented by a UE or its components as described herein. For example, the operations of the method 1800 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1805, the method may include receiving one or more SSBs indicating a first uplink transmit power and a target uplink reception power. The operations of 1805 may be performed in accordance with examples as disclosed herein. In some examples, aspects of the operations of 1805 may be performed by an SSB receiver 725 as described with reference to FIG. 7.

At 1810, the method may include transmitting a first random access message, including a preamble, according to a second uplink transmit power, where the second uplink transmit power is based on the first uplink transmit power. The operations of 1810 may be performed in accordance with examples as disclosed herein. In some examples, aspects of the operations of 1810 may be performed by a random access message transmitter 740 as described with reference to FIG. 7.

At 1815, the method may include increasing the second uplink transmit power according to a step value, the step value indicated in the one or more SSBs. The operations of 1815 may be performed in accordance with examples as disclosed herein. In some examples, aspects of the operations of 1815 may be performed by a transmit power changing component 765 as described with reference to FIG. 7.

At 1820, the method may include transmitting a repetition of the first random access message according to the increased second uplink transmit power. The operations of 1820 may be performed in accordance with examples as disclosed herein. In some examples, aspects of the operations of 1820 may be performed by a random access message transmitter 740 as described with reference to FIG. 7.

At 1825, the method may include receiving a random access response message corresponding to the first random access message, the random access response message including an indication of an uplink path loss. The operations of 1825 may be performed in accordance with examples as disclosed herein. In some examples, aspects of the operations of 1825 may be performed by a random access response message receiver 745 as described with reference to FIG. 7.

At 1830, the method may include transmitting a second random access message according to a third uplink transmit power, where the third uplink transmit power is based on the uplink path loss and the target uplink reception power. The operations of 1830 may be performed in accordance with examples as disclosed herein. In some examples, aspects of the operations of 1830 may be performed by a random access message transmitter 740 as described with reference to FIG. 7.

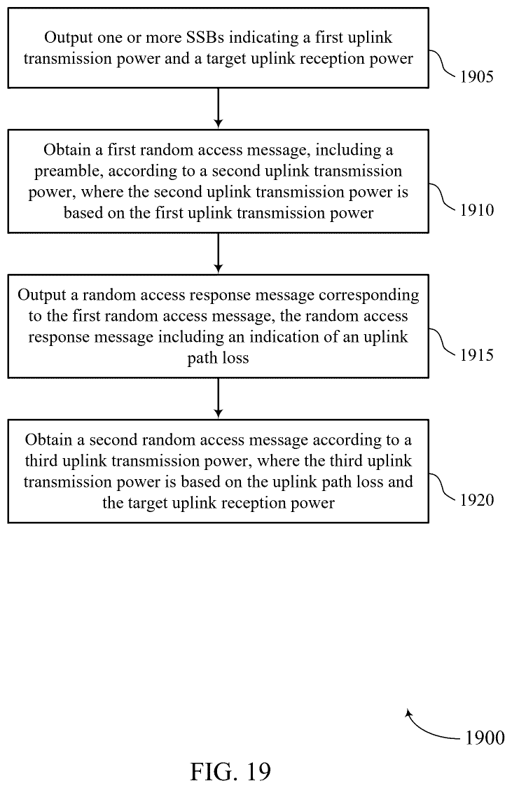

FIG. 19 shows a flowchart illustrating a method 1900 that supports open loop uplink power control in low-pass channels in accordance with one or more aspects of the present disclosure. The operations of the method 1900 may be implemented by a network entity or its components as described herein. For example, the operations of the method 1900 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1905, the method may include outputting one or more SSBs indicating a first uplink transmit power and a target uplink reception power. The operations of 1905 may be performed in accordance with examples as disclosed herein. In some examples, aspects of the operations of 1905 may be performed by an SSB manager 1125 as described with reference to FIG. 11.

At 1910, the method may include obtaining a first random access message, including a preamble, according to a second uplink transmit power, where the second uplink transmit power is based on the first uplink transmit power. The operations of 1910 may be performed in accordance with examples as disclosed herein. In some examples, aspects of the operations of 1910 may be performed by a random access message manager 1140 as described with reference to FIG. 11.

At 1915, the method may include outputting a random access response message corresponding to the first random access message, the random access response message including an indication of an uplink path loss. The operations of 1915 may be performed in accordance with examples as disclosed herein. In some examples, aspects of the operations of 1915 may be performed by a random access response message manager 1145 as described with reference to FIG. 11.

At 1920, the method may include obtaining a second random access message according to a third uplink transmit power, where the third uplink transmit power is based on the uplink path loss and the target uplink reception power. The operations of 1920 may be performed in accordance with examples as disclosed herein. In some examples, aspects of the operations of 1920 may be performed by a random access message manager 1140 as described with reference to FIG. 11.

The following provides an overview of aspects of the present disclosure:

Aspect 1: A method for wireless communication at a UE, comprising: receiving one or more SSBs indicating an uplink transmission power and a first set of optical front-end parameters associated with a network entity; transmitting, based at least in part on the one or more SSBs, control signaling according to the uplink transmission power, wherein the control signaling indicates a second set of optical front-end parameters associated with the UE; and transmitting uplink signaling according to one or more updated parameters based at least in part on the first set of optical front-end parameters associated with the network entity.

Aspect 2: The method of aspect 1, further comprising: receiving downlink signaling based at least in part on transmitting the control signaling that indicates the second set of optical front-end parameters.

Aspect 3: The method of any of aspects 1 through 2, further comprising: updating one or more parameters from an initial set of one or more parameters to the one or more updated parameters, wherein the one or more updated parameters comprise an updated transmission power for the uplink signaling.

Aspect 4: The method of any of aspects 1 through 3, wherein the one or more SSBs are received via an available bandwidth of at least one component carrier and the control signaling is transmitted via the available bandwidth of the at least one component carrier.

Aspect 5: The method of aspect 4, further comprising: receiving via the one or more SSBs, system information indicating a transmission power for the control signaling, wherein in transmitting the control signaling is based at least in part on the indicated transmission power.

Aspect 6: The method of any of aspects 4 through 5, wherein the uplink signaling is transmitted via the available bandwidth of the at least one component carrier according to the first set of optical front-end parameters.

Aspect 7: The method of any of aspects 1 through 6, wherein the one or more SSBs are received via a plurality of sub-bands, an available bandwidth of at least one component carrier is divided into the plurality of sub-bands, and the control signaling is transmitted via a first sub-band of the plurality of sub-bands.

Aspect 8: The method of aspect 7, further comprising: selecting the first sub-band from the plurality of sub-bands based at least in part on a quantity of UEs in a cell associated with the first sub-band, wherein transmitting the control signaling via the first sub-band of the plurality of sub-bands is based at least in part on the selecting.

Aspect 9: The method of any of aspects 7 through 8, wherein the uplink signaling is transmitted via the first sub-band according to the first set of optical front-end parameters.

Aspect 10: The method of any of aspects 1 through 9, further comprising receiving broadcast signaling indicating a set of candidate optical front-end parameters, a set of candidate transmission powers, or both, wherein the one or more SSBs comprise an indication of the uplink transmission power from the set of candidate transmit powers, an indication of the first set of optical front-end parameters from the set of candidate optical front-end parameters, or both.

Aspect 11: The method of any of aspects 1 through 10, wherein transmitting the uplink signaling according to the one or more updated parameters comprises: transmitting a first random access message, comprising a preamble, based at least in part on a calibration at the UE for uplink transmissions according to the one or more updated parameters; and transmitting a second random access message based at least in part on the calibration and based at least in part on receiving a random access response message, wherein receiving the random access response message is based at least in part on transmitting the first random access message.

Aspect 12: A method for wireless communication at a network entity, comprising: outputting one or more SSBs indicating an uplink transmission power and a first set of optical front-end parameters associated with the network entity; obtaining, based at least in part on the one or more SSBs, control signaling according to the uplink transmission power, wherein the control signaling indicates a second set of optical front-end parameters associated with a UE; and outputting downlink signaling according to one or more updated parameters based at least in part on the second set of optical front-end parameters associated with the UE.

Aspect 13: The method of aspect 12, further comprising: obtaining uplink signaling based at least in part on outputting the one or more SSBs that indicate the first set of optical front-end parameters.

Aspect 14: The method of any of aspects 12 through 13, further comprising: updating one or more parameters from an initial set of one or more parameters to the one or more updated parameters, wherein the one or more updated parameters comprise an updated transmission power for the downlink signaling.

Aspect 15: The method of any of aspects 12 through 14, wherein the one or more SSBs are output via an available bandwidth of at least one component carrier and the control signaling is obtained via the available bandwidth of the at least one component carrier.

Aspect 16: The method of aspect 15, further comprising: outputting, via the one or more SSBs, system information indicating a transmission power for the control signaling, wherein obtaining the control signaling is based at least in part on the indicated transmission power.

Aspect 17: The method of any of aspects 12 through 16, further comprising: outputting broadcast signaling indicating a set of candidate optical front-end parameters, a set of candidate transmission powers, or both, wherein the one or more SSBs comprise an indication of the uplink transmission power from the set of candidate transmit powers, an indication of the first set of optical front-end parameters from the set of candidate optical front-end parameters, or both.

Aspect 18: The method of any of aspects 12 through 17, wherein outputting the downlink signaling according to the one or more updated parameters comprises: outputting a first random access response message based at least in part on a calibration at the network entity for downlink transmissions according to the one or more updated parameters and based at least in part on obtaining a first random access message comprising a preamble; and outputting a second random access response message based at least in part on the calibration and based at least in part on obtaining a second random access message, wherein obtaining the second random access message is based at least in part on outputting the first random access response message.

Aspect 19: A method for wireless communication at a UE, comprising: receiving one or more SSBs indicating a first uplink transmission power and a target uplink reception power; transmitting a first random access message, comprising a preamble, according to a second uplink transmission power, wherein the second uplink transmission power is based at least in part on the first uplink transmission power; receiving a random access response message corresponding to the first random access message, the random access response message comprising an indication of an uplink path loss; and transmitting a second random access message according to a third uplink transmission power, wherein the third uplink transmission power is based at least in part on the uplink path loss and the target uplink reception power.

Aspect 20: The method of aspect 19, further comprising: increasing the second uplink transmission power according to a step value, the step value indicated in the one or more SSBs; and transmitting a repetition of the first random access message according to the increased second uplink transmission power.

Aspect 21: The method of aspect 20, further comprising: switching from a first sub-band of a plurality of sub-bands to a second sub-band of the plurality of sub-bands, wherein an available bandwidth of at least one component carrier is divided into the plurality of sub-bands; receiving a second one or more SSBs via the second sub-band, wherein the second one or more SSBs indicates a third uplink transmission power, a second target uplink reception power, and a second step value; transmitting a third random access message according to a fourth uplink transmission power, the fourth uplink transmission power based at least in part on the increased second uplink transmission power; increasing the fourth uplink transmission power according to the second step value; and transmitting a repetition of the third random access message according to the increased third uplink transmission power.

Aspect 22: The method of any of aspects 20 through 21, further comprising: switching from a first sub-band of a plurality of sub-bands to a second sub-band of the plurality of sub-bands, wherein an available bandwidth of at least one component carrier is divided into the plurality of sub-bands; receiving a second one or more SSBs via the second sub-band, wherein the second one or more SSBs indicates a third uplink transmission power, a second target uplink reception power, and a second step value; transmitting a third random access message according to the third uplink transmission power; increasing the third uplink transmission power according to a second step value, the second step value indicated in the second one or more SSBs; and transmitting a repetition of the third random access message according to the increased third uplink transmission power.

Aspect 23: The method of any of aspects 19 through 22, further comprising: measuring a downlink path loss based at least in part on receiving the one or more SSBs, wherein the second uplink transmission power is based at least in part on the downlink path loss.

Aspect 24: The method of any of aspects 19 through 23, wherein the one or more SSBs are received via a plurality of sub-bands, an available bandwidth of at least one component carrier is divided into the plurality of sub-bands, and the first random access message is transmitted via a first sub-band of the plurality of sub-bands.

Aspect 25: The method of any of aspects 19 through 24, wherein the one or more SSBs are received via an available bandwidth of at least one component carrier and the random access message is transmitted via the available bandwidth of the at least one component carrier.

Aspect 26: The method of aspect 25, wherein the random access response message, comprising a second target uplink reception power for a sub-band of a plurality of sub-bands, is received via the sub-band, the available bandwidth of the at least one component carrier is divided into the plurality of sub-bands, and the second random access message is transmitted via the sub-band according to the second target uplink reception power.

Aspect 27: The method of aspect 26, further comprising: selecting the sub-band from the plurality of sub-bands based at least in part on the uplink path loss and the second target uplink reception power.

Aspect 28: The method of any of aspects 19 through 27, wherein the first uplink transmission power and the second uplink transmission power are the same.

Aspect 29: The method of any of aspects 19 through 28, further comprising: selecting a preamble sequence, wherein transmitting the first random access message is based at least in part on the preamble sequence.

Aspect 30: A method for wireless communication at a network entity, comprising: outputting one or more SSBs indicating a first uplink transmission power and a target uplink reception power; obtaining a first random access message, comprising a preamble, according to a second uplink transmission power, wherein the second uplink transmission power is based at least in part on the first uplink transmission power; outputting a random access response message corresponding to the first random access message, the random access response message comprising an indication of an uplink path loss; and obtaining a second random access message according to a third uplink transmission power, wherein the third uplink transmission power is based at least in part on the uplink path loss and the target uplink reception power.

Aspect 31: A UE for wireless communication, comprising one or more memories storing processor-executable code, and one or more processors coupled with the one or more memories and individually or collectively operable to execute the code to cause the UE to perform a method of any of aspects 1 through 11.

Aspect 32: A UE for wireless communication, comprising at least one means for performing a method of any of aspects 1 through 11.

Aspect 33: A non-transitory computer-readable medium storing code for wireless communication, the code comprising instructions executable by one or more processors to perform a method of any of aspects 1 through 11.

Aspect 34: A network entity for wireless communication, comprising one or more memories storing processor-executable code, and one or more processors coupled with the one or more memories and individually or collectively operable to execute the code to cause the network entity to perform a method of any of aspects 12 through 18.

Aspect 35: A network entity for wireless communication, comprising at least one means for performing a method of any of aspects 12 through 18.

Aspect 36: A non-transitory computer-readable medium storing code for wireless communication, the code comprising instructions executable by one or more processors to perform a method of any of aspects 12 through 18.

Aspect 37: A UE for wireless communication, comprising one or more memories storing processor-executable code, and one or more processors coupled with the one or more memories and individually or collectively operable to execute the code to cause the UE to perform a method of any of aspects 19 through 29.

Aspect 38: A UE for wireless communication, comprising at least one means for performing a method of any of aspects 19 through 29.

Aspect 39: A non-transitory computer-readable medium storing code for wireless communication, the code comprising instructions executable by one or more processors to perform a method of any of aspects 19 through 29.

Aspect 40: A network entity for wireless communication, comprising one or more memories storing processor-executable code, and one or more processors coupled with the one or more memories and individually or collectively operable to execute the code to cause the network entity to perform a method of any of aspect 30.

Aspect 41: A network entity for wireless communication, comprising at least one means for performing a method of aspect 30.

Aspect 42: A non-transitory computer-readable medium storing code for wireless communication, the code comprising instructions executable by one or more processors to perform a method of any of aspects aspect 30.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, including in the claims, the term “set” may refer to a set of one item, or a set of multiple items.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive one or more synchronization signal blocks (SSBs) indicating an uplink transmit power and a first set of optical front-end parameters associated with a network entity;
transmit, based at least in part on the one or more SSBs, control signaling according to the uplink transmit power, wherein the control signaling indicates a second set of optical front-end parameters associated with the UE; and
transmit uplink signaling according to one or more updated parameters based at least in part on the first set of optical front-end parameters associated with the network entity.

2. The UE of claim 1, wherein the one or more processors are individually or collectively further operable to execute the code to cause the UE to:
receive downlink signaling based at least in part on transmitting the control signaling that indicates the second set of optical front-end parameters.

3. The UE of claim 1, wherein the one or more processors are individually or collectively further operable to execute the code to cause the UE to:
update one or more parameters from an initial set of one or more parameters to the one or more updated parameters, wherein the one or more updated parameters comprise an updated transmit power for the uplink signaling.

4. The UE of claim 1, wherein the one or more SSBs are received via an available bandwidth of at least one component carrier and the control signaling is transmitted via the available bandwidth of the at least one component carrier.

5. The UE of claim 4, wherein the one or more processors are individually or collectively further operable to execute the code to cause the UE to:
receive via the one or more SSBs, system information indicating a transmit power for the control signaling, wherein in transmitting the control signaling is based at least in part on the indicated transmit power.

6. The UE of claim 4, wherein the uplink signaling is transmitted via the available bandwidth of the at least one component carrier according to the first set of optical front-end parameters.

7. The UE of claim 1, wherein the one or more SSBs are received via a plurality of sub-bands, an available bandwidth of at least one component carrier is divided into the plurality of sub-bands, and the control signaling is transmitted via a first sub-band of the plurality of sub-bands.

8. The UE of claim 7, wherein the one or more processors are individually or collectively further operable to execute the code to cause the UE to:
select the first sub-band from the plurality of sub-bands based at least in part on a quantity of UEs in a cell associated with the first sub-band, wherein transmitting the control signaling via the first sub-band of the plurality of sub-bands is based at least in part on the selecting.

9. The UE of claim 7, wherein the uplink signaling is transmitted via the first sub-band according to the first set of optical front-end parameters.

10. The UE of claim 1, wherein the one or more processors are individually or collectively further operable to execute the code to cause the UE to:
receive broadcast signaling indicating a set of candidate optical front-end parameters, a set of candidate transmit powers, or both, wherein the one or more SSBs comprise an indication of the uplink transmit power from the set of candidate transmit powers, an indication of the first set of optical front-end parameters from the set of candidate optical front-end parameters, or both.

11. The UE of claim 1, wherein, to transmit the uplink signaling according to the one or more updated parameters, the one or more processors are individually or collectively operable to execute the code to cause the UE to:
transmit a first random access message, comprising a preamble, based at least in part on a calibration at the UE for uplink transmissions according to the one or more updated parameters; and
transmit a second random access message based at least in part on the calibration and based at least in part on receiving a random access response message, wherein receiving the random access response message is based at least in part on transmitting the first random access message.

12. A network entity, comprising:
one or more memories storing processor-executable code; and
one or more processors coupled with the one or more memories and individually or collectively operable to execute the code to cause the network entity to:
output one or more synchronization signal blocks (SSBs) indicating an uplink transmit power and a first set of optical front-end parameters associated with the network entity;
obtain, based at least in part on the one or more SSBs, control signaling according to the uplink transmit power, wherein the control signaling indicates a second set of optical front-end parameters associated with a user equipment (UE); and
output downlink signaling according to one or more updated parameters based at least in part on the second set of optical front-end parameters associated with the UE.

13. The network entity of claim 12, wherein the one or more processors are individually or collectively further operable to execute the code to cause the network entity to:
obtain uplink signaling based at least in part on outputting the one or more SSBs that indicate the first set of optical front-end parameters.

14. The network entity of claim 12, wherein the one or more processors are individually or collectively further operable to execute the code to cause the network entity to:
update one or more parameters from an initial set of one or more parameters to the one or more updated parameters, wherein the one or more updated parameters comprise an updated transmit power for the downlink signaling.

15. The network entity of claim 12, wherein the one or more SSBs are output via an available bandwidth of at least one component carrier and the control signaling is obtained via the available bandwidth of the at least one component carrier.

16. The network entity of claim 15, wherein the one or more processors are individually or collectively further operable to execute the code to cause the network entity to:
output, via the one or more SSBs, system information indicating a transmit power for the control signaling, wherein obtaining the control signaling is based at least in part on the indicated transmit power.

17. The network entity of claim 12, wherein the one or more processors are individually or collectively further operable to execute the code to cause the network entity to:
output broadcast signaling indicating a set of candidate optical front-end parameters, a set of candidate transmit powers, or both, wherein the one or more SSBs comprise an indication of the uplink transmit power from the set of candidate transmit powers, an indication of the first set of optical front-end parameters from the set of candidate optical front-end parameters, or both.

18. The network entity of claim 12, wherein, to output the downlink signaling according to the one or more updated parameters, the one or more processors are individually or collectively operable to execute the code to cause the network entity to:
output a first random access response message based at least in part on a calibration at the network entity for downlink transmissions according to the one or more updated parameters and based at least in part on obtaining a first random access message comprising a preamble; and
output a second random access response message based at least in part on the calibration and based at least in part on obtaining a second random access message, wherein obtaining the second random access message is based at least in part on outputting the first random access response message.

19. A user equipment (UE), comprising:
one or more memories storing processor-executable code; and
one or more processors coupled with the one or more memories and individually or collectively operable to execute the code to cause the UE to:
receive one or more synchronization signal blocks (SSBs) indicating a first uplink transmit power and a target uplink reception power;
transmit a first random access message, comprising a preamble, according to a second uplink transmit power, wherein the second uplink transmit power is based at least in part on the first uplink transmit power;
receive a random access response message corresponding to the first random access message, the random access response message comprising an indication of an uplink path loss; and
transmit a second random access message according to a third uplink transmit power, wherein the third uplink transmit power is based at least in part on the uplink path loss and the target uplink reception power.

20. The UE of claim 19, wherein the one or more processors are individually or collectively further operable to execute the code to cause the UE to:
increase the second uplink transmit power according to a step value, the step value indicated in the one or more SSBs; and
transmit a repetition of the first random access message according to the increased second uplink transmit power.

21. The UE of claim 20, wherein the one or more processors are individually or collectively further operable to execute the code to cause the UE to:
switch from a first sub-band of a plurality of sub-bands to a second sub-band of the plurality of sub-bands, wherein an available bandwidth of at least one component carrier is divided into the plurality of sub-bands;
receive a second one or more SSBs via the second sub-band, wherein the second one or more SSBs indicates a third uplink transmit power, a second target uplink reception power, and a second step value;
transmit a third random access message according to a fourth uplink transmit power, the fourth uplink transmit power based at least in part on the increased second uplink transmit power;
increase the fourth uplink transmit power according to the second step value; and
transmit a repetition of the third random access message according to the increased third uplink transmit power.

22. The UE of claim 20, wherein the one or more processors are individually or collectively further operable to execute the code to cause the UE to:
switch from a first sub-band of a plurality of sub-bands to a second sub-band of the plurality of sub-bands, wherein an available bandwidth of at least one component carrier is divided into the plurality of sub-bands;
receive a second one or more SSBs via the second sub-band, wherein the second one or more SSBs indicates a third uplink transmit power, a second target uplink reception power, and a second step value;
transmit a third random access message according to the third uplink transmit power;
increase the third uplink transmit power according to a second step value, the second step value indicated in the second one or more SSBs; and
transmit a repetition of the third random access message according to the increased third uplink transmit power.

23. The UE of claim 19, wherein the one or more processors are individually or collectively further operable to execute the code to cause the UE to:
measure a downlink path loss based at least in part on receiving the one or more SSBs, wherein the second uplink transmit power is based at least in part on the downlink path loss.

24. The UE of claim 19, wherein the one or more SSBs are received via a plurality of sub-bands, an available bandwidth of at least one component carrier is divided into the plurality of sub-bands, and the first random access message is transmitted via a first sub-band of the plurality of sub-bands.

25. The UE of claim 19, wherein the one or more SSBs are received via an available bandwidth of at least one component carrier and the random access message is transmitted via the available bandwidth of the at least one component carrier.

26. The UE of claim 25, wherein, the random access response message, comprising a second target uplink reception power for a sub-band of a plurality of sub-bands, is received via the sub-band, the available bandwidth of the at least one component carrier is divided into the plurality of sub-bands, and the second random access message is transmitted via the sub-band according to the second target uplink reception power.

27. The UE of claim 26, wherein the one or more processors are individually or collectively further operable to execute the code to cause the UE to:
select the sub-band from the plurality of sub-bands based at least in part on the uplink path loss and the second target uplink reception power.

28. The UE of claim 19, wherein the first uplink transmit power and the second uplink transmit power are the same.

29. The UE of claim 19, wherein the one or more processors are individually or collectively further operable to execute the code to cause the UE to:
select a preamble sequence, wherein transmitting the first random access message is based at least in part on the preamble sequence.

30. A network entity, comprising:
one or more memories storing processor-executable code; and
one or more processors coupled with the one or more memories and individually or collectively operable to execute the code to cause the network entity to:
output one or more synchronization signal blocks (SSBs) indicating a first uplink transmit power and a target uplink reception power;
obtain a first random access message, comprising a preamble, according to a second uplink transmit power, wherein the second uplink transmit power is based at least in part on the first uplink transmit power;
output a random access response message corresponding to the first random access message, the random access response message comprising an indication of an uplink path loss; and
obtain a second random access message according to a third uplink transmit power, wherein the third uplink transmit power is based at least in part on the uplink path loss and the target uplink reception power.
